(19) United States
(12) Patent Application Publication
(10) Pub. No.: US 2020/0273113 A1
(43) Pub. Date: Aug. 27, 2020

(54) Computer-Implemented System and Method for Dynamically Adjusted Targeted Terms of Contractual Services Involving Monitored Drivers

(71) Applicant: Buckle Corp., Jersey City, NJ (US)

(72) Inventors: Dustin Walsey, Atlanta, GA (US); Martin Young, West Chester, PA (US)

(21) Appl. No.: 16/865,658

(22) Filed: May 4, 2020

Related U.S. Application Data
(63) Continuation-in-part of application No. 16/126,051, filed on Sep. 10, 2018.
(60) Provisional application No. 62/557,439, filed on Sep. 12, 2017.

(51) Int. Cl. G06Q 40/08; G06Q 10/10; G06Q 50/30

(52) U.S. Cl. CPC G06Q 40/08; G06Q 50/30; G06Q 10/1057

(57) ABSTRACT

A computer-implemented method uses computer processes, executing on an administrator server system, for administering a program having a targeted set of terms, based on a set of contracts involving a set of services, pertaining to monitored drivers, wherein the targeted terms are dynamically updated based on driver performance and market conditions. The computer processes additionally facilitate applying on behalf of an applicant set of the monitored drivers to a government agency for monetary relief The computer processes include receiving, by the administrator server system, a set of first data feeds from a set of servers of a set of monitoring companies that (i) compensate the monitored drivers for driving services or (ii) provide non-driving contractual services to the drivers or (iii) both compensate the monitored drivers for the driving services and provide the non-driving contractual services to the monitored drivers. Each one of the monitored drivers performs services as a driver of a motor vehicle of which the use is monitored in real time by means of at least one application executing on a mobile computing device in communication with a server operated by one of the monitoring companies.

### RELATED APPLICATION

The present application is a continuation-in-part of application Ser. No. 16/126,051, filed Sep. 10, 2018, which claims the benefit of provisional application Ser. No. 62/557,439, filed Sep. 12, 2017, entitled “Computer-Implemented System and Method for Dynamic Market Making and Rebating,” and naming the same inventors as the inventors herein. Each of these applications is hereby incorporated herein by reference in its entirety.

### TECHNICAL FIELD

The present invention relates to computer-implemented systems and methods for dynamically adjusting targeted terms of contractual services, and, in particular, computer-implemented systems and methods for dynamically adjusting targeted terms of contractual services involving drivers, each of whom performs services as a driver of a motor vehicle of which the use is monitored, whether periodically or in real time, by means of an application executing on a mobile computing device.

### BACKGROUND ART

Drivers for ride-for-hire services (sometimes referred to herein as “rideshare” or “ridesharing” services or transportation network companies (TNC) or transportation network providers (TNP)) are generally required to have appropriate auto and other liability insurance. Not all insurance companies offer rideshare insurance policies, nor has coverage been widely available in all states. If rideshare insurance is not available to a particular driver or the driver's vehicle (whether owned or leased), the driver may need to buy a commercial auto insurance policy (possibly in addition to a personal auto insurance policy). Commercial auto insurance is generally much more expensive than personal auto insurance, so there can be a cost involved with driving for the ridesharing service. Some ridesharing services provide supplemental insurance coverage, but generally only while driving for the ridesharing service. Still, there can be coverage gaps between the driver's personal auto insurance and the supplemental insurance coverage, and it is highly recommended that drivers obtain ridesharing or commercial insurance to fill in coverage gaps. The issue of insurance can be further complicated when drivers drive for multiple ridesharing or delivery services.

### SUMMARY OF THE EMBODIMENTS

In accordance with one embodiment of the invention, there is provided a computer-implemented method, using computer processes executing on an administrator server system, for administering a program having a targeted set of terms, based on a set of contracts involving a set of services, pertaining to monitored drivers, wherein the targeted terms are dynamically updated based on driver performance and market conditions. In this embodiment, the computer processes include receiving, by the administrator server system, a set of first data feeds from a set of servers of a set of monitoring companies that (i) compensate the monitored drivers for driving services or (ii) provide non-driving contractual services to the drivers or (iii) both compensate the monitored drivers for the driving services and provide the non-driving contractual services to the monitored drivers, wherein each one of the monitored drivers performs services as a driver of a motor vehicle of which the use is monitored in real time by means of at least one application executing on a mobile computing device in communication with a server operated by one of the monitoring companies, wherein such first data feeds provide contemporaneous information concerning performance of the monitored drivers.

Additionally, the processes include maintaining a driver database containing data, as to a set of the monitored drivers, wherein the driver database includes the targeted set of terms of the contractual service; parsing, by the administrator server system, the first data feeds in relation to the set of monitored drivers, to derive updated data pertinent to one or more affected drivers in the first set, and, processing the updated data. In turn, the processing of the updated data is achieved by storing, by the administrator server system, the updated data in relation to the affected drivers in the driver database; in a performance review process, evaluating the updated data in relation to other data in the driver database with respect to each affected driver to determine a result with respect to the targeted set of terms for each affected driver; and in a result communication process, communicating by the administrative server system the result to each affected driver.

In a further related embodiment, the contractual service is motor vehicle insurance and the result, determined by the performance review process, is a rebate on a premium charged for the motor vehicle insurance. In another related embodiment, the contractual service is health insurance and the result, determined by the performance review process, is a rebate on a premium charged for the health insurance.

In another related embodiment, the contractual service is selected from the group consisting of life insurance, disability insurance, workman's compensation insurance, home or renter's insurance, commercial liability insurance, and umbrella insurance and the result, determined by the performance review process, is a rebate on a premium charged for such insurance.

In another related embodiment, the contractual service is a loan, and the result, determined by the performance review process, is a rebate on consideration charged for the loan. In another related embodiment, the contractual service is provision of a consumable, and the result, determined by the performance review process, is a rebate on the charges for the consumable. In another related embodiment, the contractual service is a car buying service, and the result, determined by the performance review process, is a rebate on the charges for buying or leasing an automobile. In another related embodiment, the contractual service is a referral service of a product or service to another rideshare driver, and the result, determined by the performance review process is a rebate on the charges for said product or service referred.

In a further related embodiment, the computer processes comprise receiving, by the administrative server system, a set of second data feeds from a set of servers operated by a set of information partners; parsing, by the administrator server system, the second data feeds in relation to the set of monitored drivers, to derive additional information also pertinent to the one or more affected drivers in the first set, and processing this additional information as a part of processing the updated data.

In yet another related embodiment, the computer processes further comprise, as a condition to providing the motor vehicle insurance, determining eligibility of each one of the set of monitored drivers for the motor vehicle insurance; if such one of the monitored drivers is determined to be eligible then also determining a base rate and initial rebate for such insurance; and transmitting to the mobile computing device of such one of the monitored drivers an offer message containing terms of such insurance including the base rate and the initial rebate.

In another related embodiment, there is provided a computer-implemented method, wherein the mobile computing device monitoring use of the motor vehicle is carried in a manner selected from the group consisting of (i) carried by the driver, (ii) installed in the vehicle, (iii) carried by a passenger when the vehicle is used for providing a ride service, (iv) placed on or in a package when the vehicle is used for providing a delivery service, and (v) combinations of the foregoing.

In accordance with another embodiment of the invention, there is provided a computer-implemented method for binding a contract with an applicant on a policy of insurance using computer processes, executing on a server system, and communicating such binding to other interested parties, includes computer processes comprising receiving by the server system, over the wide area network, at least one message with information confirming an acceptance by the applicant of an offer of the insurance and an agreement to pay for the insurance; storing, by the server system, data in the at least one message in at least one of the databases selected from the database group consisting of an application database, a client database, a payment database, a contract database, a partner database, a social media database, rebate program database, a compliance database, a property database, property log database (such as a trip log), a claims database, and a loss database; after completion of a payment process managed by the server system, updating by the server system the selected databases to reflect the completion; and sending, over a wide area network, by the server system, an endpoint of the applicant, a message confirming binding of the contract on the policy of insurance.

In accordance with another embodiment of the invention, there is provided a computer-implemented method for re-assessing continued product policy eligibility, market pricing and rebates using computer processes, executing on a server system, to dynamically determine eligibility, market pricing and rebate programs, includes computer processes comprising receiving by the server system, over the wide area network, at least one client update message providing data that is an update, with respect to a named client, as to data in at least one of the databases selected from the database group consisting of an application database, a client database, a payment database, a contract database, a partner database, a social media database, rebate program database, a compliance database, a property database, property log database, a claims database, and a loss database; in an eligibility process, processing by the server system any updated data in the selected databases in the database group to determine whether an eligibility status of the named client has changed; in the event the eligibility status has changed, then storing the updated eligibility status and transmitting by the server system, over the wide area network, to an endpoint of the named client an updated eligibility message containing information explaining the change in eligibility status; and in the event that the named client has continued eligibility, performing by the server system a market making process to determine an updating Base Rate and an updated rebating process to determine an updated Rebate Rate.

In accordance with another embodiment of the invention, there is provided a computer-implemented method for communicating terminations of product or service by using computer processes, executing on a server system, to update the client and interested parties on the client's status, This embodiment includes computer processes comprising if the client is not eligible (such as an insured is not insurable), transmitting by the server system, over the wide area network, a message with confirmation of contract termination to the endpoints of at least one of the following: client and appropriate partner parties; after transmission of the message of contract termination, a payment process that calculates the final monies owed to the client or owed by the client and transmits a message by the server system, over the wide area network, to the endpoint of the client containing information the reconciles all payments.

In accordance with another embodiment of the invention, there is provided a computer-implemented method for dynamic market making and rebating using computer processes, executing on a server system, to dynamically update Net Payment due. In the embodiment, the computer processes comprise after completion of offering, payment and binding computer processes by the server system causing transmission of a contract binding message, over a wide area network, to an endpoint of a client (such as a named insured), specifying a base rate and an initial rebate rate; receiving by the server system, over the wide area network, at least one client update message providing data that is an update, with respect to a client, as to data in at least one of the databases selected from the database group consisting of an application database, a client database, a payment database, a contract database, a partner database, a social media database, rebate program database, a compliance database, a property database, property log database, a claims database, and a loss database; processing by the server system the client update message to cause corresponding updating of corresponding databases in the database group; in an eligibility, market making and rebating update process, processing by the server system any updated data in databases in the database group pertinent to the client to determine any adjustment to Current Base Rate to produce an updated Base Rate and/or any adjustment to a current rebate rate to produce an updated rebate rate; in the event of an updated base or rebate rate, then storing the updated Base or rebate rate as the current Base or Rebate Rate respectively and calculating the Net Policy Payment based on the then current base rate and rebate rate; transmitting by the server system, over the wide area network, to the endpoint of a client a Net Payment message containing information about the updated rebate rate, base rate and Net Policy Payment.

In accordance with another embodiment of the invention, there is provided a computer-implemented method, using computer processes executing on an administrator server system, for administering a program providing a contractual service to monitored entities under terms that are dynamically updated based on performance of the monitored entities and market conditions. This embodiment, includes computer processes comprising receiving, by the administrator server system, a set of first data feeds from a set of servers of a set of monitoring companies, the first set of data feeds providing data from monitored entities, each one of which is monitored in real time by means of at least one application, executing on a computing device associated with a person or business, in communication with a server operated by one of the monitoring companies, wherein such first data feeds provide contemporaneous information concerning performance of the monitored entities; maintaining a database containing data, as to a set of the monitored entities, being provided with the contractual service, wherein the database includes terms of the contractual service; parsing, by the administrator server system, the first data feeds in relation to the set of monitored entities, to derive updated data pertinent to one or more affected entities in the first set, and, processing the updated data by storing, by the administrator server system, the updated data in relation to the affected entities in the database; in a performance review process, evaluating the updated data in relation to other data in the database with respect to each affected entity to determine a result on the contractual service to each affected entity; and in a result communication process, communicating by the administrative server system the result to each affected entity. In a further embodiment of the computer-implemented method, the contractual service is insurance and the result, determined by the performance review process, is a rebate on a premium charged for the insurance.

In accordance with another embodiment of the invention, there is provided a computer-implemented method, using computer processes executing on an administrator server system, that administers a program having a targeted set of terms, based on a set of contracts involving a set of services, pertaining to monitored drivers. The computer processes additionally facilitate applying on behalf of an applicant set of the monitored drivers to a government agency for monetary relief. The computer processes of this embodiment include receiving, by the administrator server system, a set of first data feeds from a set of servers of a set of monitoring companies that (i) compensate the monitored drivers for driving services or (ii) provide non-driving contractual services to the drivers or (iii) both compensate the monitored drivers for the driving services and provide the non-driving contractual services to the monitored drivers. Each one of the monitored drivers performs services as a driver of a motor vehicle of which the use is monitored in real time by means of at least one application executing on a mobile computing device in communication with a server operated by one of the monitoring companies, wherein such first data feeds provide contemporaneous information concerning performance of the monitored drivers. The computer processes also include maintaining a driver database containing data, as to a set of the monitored drivers, wherein the driver database includes the targeted set of terms of the contractual service. The computer processes further include parsing, by the administrator server system, the first data feeds in relation to the set of monitored drivers, to derive updated data pertinent to one or more affected drivers in the set. The computer processes process the updated data by storing, by the administrator server system, the updated data in relation to the affected drivers in the driver database; in a performance review process, evaluating the updated data in relation to other data in the driver database with respect to each affected driver to determine an adjustment with respect to the targeted set of terms for each affected driver; and in a result communication process, communicating by the administrative server system an adjustment to each affected driver. The targeted terms are dynamically adjusted based at least on contemporaneous driver performance determined at least in part by the set of data feeds from the set of servers of the set of monitoring companies. In a submission process, for each driver in the application set of drivers, the computer processes also include populating, by the administrator server system, an electronic application form, in a format approved by the agency and pertinent to the monetary relief, with information, pertinent to the form and relating to such driver, the information derived from the driver database; identifying, by the administrator server system, in the application form, any unpopulated fields required to be completed; prompting, by the administrator server system, such driver for, and receiving from such driver, completion information needed to populate the unpopulated fields; using, by the administrator server system, the completion information to populate the unpopulated fields; and thereafter submitting, by the administrator server system and on behalf of such driver, the form, as fully populated, to the agency.

Optionally, the information derived from the driver database includes combined gross revenue of such driver from the set of monitoring companies. Optionally, the information derived from the driver database includes combined cost of goods sold by such driver from the set of monitoring companies. Optionally, submitting the form includes causing, by the administrator server system, prompting of such driver for, and receiving from such driver, an electronic signature.

Optionally, the completion information includes a data item selected from the group consisting of personal information of such driver, business information of such driver, financial information of such driver, and combinations thereof. Optionally, the government agency is the Small Business Administration (SBA). Optionally, the monetary relief is disaster relief. Optionally, the computer processes further comprise causing, by the administrator server system, presentation of the form to such driver, and prompting of such driver for the completion information, via an application executing on a computing device, operated by such driver, in communication with the administrator server system.

Optionally, the contractual service is selected from the group consisting of life insurance, health insurance, motor vehicle insurance, disability insurance, workman's compensation insurance, home or renter's insurance, commercial liability insurance, umbrella insurance, a loan, a provision on a consumable, a car buying service, a referral service, and the result, determined by the performance review process, is a rebate on the contractual service. Optionally, the mobile computing device monitoring use of the motor vehicle is carried in a manner selected from the group consisting of (i) carried by the driver, (ii) installed in the vehicle, (iii) carried by a passenger when the vehicle is used for providing a ride service, (iv) affixed to or contained in a package when the vehicle is used for providing a package delivery service, and (v) combinations of the foregoing.

### BRIEF DESCRIPTION OF THE DRAWINGS

The foregoing features of embodiments will be more readily understood by reference to the following detailed description, taken with reference to the accompanying drawings, in which:

FIG. 1 is a schematic diagram showing various types of entities that may be involved with insurance and rebate programs administered by an administrator server system, in accordance with an exemplary embodiment.

FIG. 2 is a schematic diagram showing various elements of the Server System, in accordance with an exemplary embodiment.

FIG. 3 is a schematic diagram demonstrating application process in which an applicant applies to become a member of the population of drivers who are eligible for insurance and/or rebates, in accordance with an exemplary embodiment.

FIG. 4 is a schematic diagram showing a set of workflows that onboard and validate a new potential client, in accordance with an exemplary embodiment.

FIG. 5 is a schematic diagram demonstrating how a potential client, with a valid account, can provide all the details necessary about themselves and their household as part of an insurance application, in accordance with an exemplary embodiment.

FIG. 6 is a schematic diagram showing how the potential client can enter in their vehicle information, in accordance with an exemplary embodiment.

FIG. 7 is a schematic diagram showing some types of information stored in an application file in the application database, in accordance with an exemplary embodiment.

FIG. 8 is a schematic diagram demonstrating product eligibility process, in accordance with an exemplary embodiment.

FIG. 9 is a schematic diagram demonstrating market making process, in accordance with an exemplary embodiment.

FIG. 10 is a schematic diagram demonstrating offering process, in accordance with an exemplary embodiment.

FIG. 11 is a schematic diagram demonstrating payment process, in accordance with an exemplary embodiment.

FIG. 12 is a schematic diagram demonstrating binding process, in accordance with an exemplary embodiment.

FIG. 13 is a schematic diagram demonstrating partner update process, in accordance with an exemplary embodiment.

FIG. 14 is a schematic diagram demonstrating partner update process for a rideshare example, in accordance with an exemplary embodiment.

FIG. 15 is a schematic diagram demonstrating partner update process for an insurance claim example, in accordance with an exemplary embodiment.

FIG. 16 is a schematic diagram demonstrating partner update process for a social media example, in accordance with an exemplary embodiment.

FIG. 17 is a schematic diagram demonstrating rebate program process for setting up a rebate program, in accordance with an exemplary embodiment.

FIG. 18 is a schematic diagram showing information from the rebate program message stored in a rebate program file in the rebate program database, in accordance with an exemplary embodiment.

FIG. 19 is a schematic diagram demonstrating an eligibility, market making, and rebate update process, in accordance with an exemplary embodiment.

FIG. 20 is a schematic diagram providing second exemplary results from rebate calculations such as in block 1912 of FIG. 19, in accordance with one exemplary embodiment.

FIG. 21 is a schematic diagram demonstrating net payment process, in accordance with an exemplary embodiment.

FIG. 22 is a schematic diagram providing an example of a net payment based on the results from the rebate calculations of FIG. 20, in accordance with one exemplary embodiment.

FIG. 23 is a schematic diagram of a system for administering insurance with rebate incentives, in accordance with an exemplary embodiment.

FIG. 24 is a schematic diagram showing a rebate program file, in accordance with an exemplary embodiment.

FIG. 25 is a schematic diagram providing first exemplary results from rebate calculations such as in block 1912 of FIG. 19 using the exemplary rebate program file 1802 of FIG. 24, in accordance with one exemplary embodiment.

FIG. 26 is a schematic diagram showing an opening user interface screen in “wireframe” form for an applicant, such as a rideshare driver, to apply for insurance with rebates, in accordance with one exemplary embodiment.

FIG. 27 is a schematic diagram showing a user interface screen in “wireframe” form for the applicant to input data to generate an application for insurance with rebates, in accordance with one exemplary embodiment.

FIG. 28 is a schematic diagram showing a user interface screen in “wireframe” form for the applicant to provide information about the applicant's partner accounts (such as rideshare companies for which the applicant drives, social media partners or delivery companies), in accordance with one exemplary embodiment.

FIG. 29 is a schematic diagram showing a user interface screen in “wireframe” form for providing confirmation to the applicant after partner authentication, in accordance with one exemplary embodiment.

FIG. 30 is a schematic diagram showing a user interface screen in “wireframe” form for the applicant to upload various types of pictures used in the application process, in accordance with one exemplary embodiment.

FIG. 31 is a schematic diagram showing a user interface screen in “wireframe” form for the applicant to enter and/or correct vehicle information, in accordance with one exemplary embodiment.

FIG. 32 is a schematic diagram showing a user interface screen in “wireframe” form for the applicant to select coverages for the vehicle, in accordance with one exemplary embodiment.

FIG. 33 is a schematic diagram showing a user interface screen in “wireframe” form for the applicant to enter, correct, and comment on any traffic violations of the applicant, in accordance with one exemplary embodiment.

FIG. 34 is a schematic diagram showing a user interface screen in “wireframe” form for providing insurance premium information to the applicant, in accordance with one exemplary embodiment.

FIG. 35 is a schematic diagram showing a user interface screen in “wireframe” form for the applicant to select rebate programs for which the applicant is eligible, in accordance with one exemplary embodiment. For example, the Server System 102 may present rebate programs for which the applicant is eligible, and the applicant may select some or all rebates programs.

FIG. 36 is a schematic diagram showing a user interface screen in “wireframe” form for providing updated insurance premium information to the applicant after eligible rebates (e.g., initial sign-up rebate), in accordance with one exemplary embodiment.

FIG. 37 is a schematic diagram showing a user interface screen in “wireframe” form for the applicant to enter payment information to pay the updated insurance premium, in accordance with one exemplary embodiment.

FIG. 38 is a schematic diagram showing a user interface screen in “wireframe” form for confirming receipt of payment, in accordance with one exemplary embodiment.

FIG. 39 is a schematic diagram showing a user interface screen in “wireframe” form for the applicant to sign various documents involved with the application process, in accordance with one exemplary embodiment.

FIG. 40 is a schematic diagram showing a user interface screen in “wireframe” form for confirming completion of the application process, in accordance with one exemplary embodiment.

FIG. 41 is a schematic diagram showing a configuration, in accordance with an embodiment of the present invention, by which a driver becomes a monitored driver when the driver operates independently as an individual transportation network provider (TNP).

FIG. 42 is a schematic diagram showing a configuration, in accordance with an embodiment of the present invention, by which a driver becomes a monitored driver when the driver operates as one of a team of drivers of a fleet of vehicles managed by a fleet operator that serves as a transportation network provider.

FIG. 43 is a schematic diagram showing a configuration, in accordance with an embodiment of the present invention, by which a driver becomes a monitored driver when the driver operates a motor vehicle for the purpose of providing a package delivery service either individually or as one of a team of drivers of a fleet of vehicles of a transportation network provider.

FIG. 44 is a block diagram showing architecture of a system, in accordance with an embodiment of the present invention, by which the Server System of FIG. 2 facilitates applying on behalf of a driver to a government agency for monetary relief, using, in part, the driver's data received from monitoring companies.

FIG. 45 is a block diagram of logical flow associated with a submission process, executed by the Server System of FIG. 2 in the configuration of FIG. 44, using an electronic application form populated, in part, with the driver's data received from the monitoring companies, in accordance with an exemplary embodiment of the present invention.

FIG. 46 is a representation of a display coupled to the Server System and presenting a user interface for entry of login information, by a driver, to access an electronic application form for applying to a government agency for monetary relief, in accordance with one exemplary embodiment of the present invention.

FIGS. 47A-47C are representations of a user interface screen presenting the electronic application form accessible via the login screen of FIG. 46, in accordance with one exemplary embodiment of the present invention.

FIG. 48 is a representation of a user interface screen which a driver can enter an electronic signature to indicate approval of the completed electronic application form of FIGS. 47A-47C, in accordance with one exemplary embodiment of the present invention.

FIG. 49 is a representation of a screen providing to the user a confirmation of submission of the completed and approved electronic application form of FIGS. 47A-47C to the government agency, in accordance with one exemplary embodiment of the present invention.

FIG. 50 is a representation of a dashboard screen providing status information as to which monitoring companies are online and thus active in providing, to the Server System of FIG. 2, driver data that is included in calculations used to populate the electronic application form of FIGS. 47A-47C, in accordance with one exemplary embodiment of the present invention.

It should be noted that the foregoing figures and the elements depicted therein are not necessarily drawn to consistent scale or to any scale. Unless the context otherwise suggests, like elements are indicated by like numerals.

### DETAILED DESCRIPTION OF SPECIFIC EMBODIMENTS

Definitions. As used in this description and the accompanying claims, the following terms shall have the meanings indicated, unless the context otherwise requires.

A “monitored driver” is an individual who performs services as a driver of a motor vehicle of which the use is monitored, whether periodically or in real time, by means of an application executing on a mobile computing device. In turn, in various embodiments, the mobile computing device may be installed in the motor vehicle, or carried by the driver, or carried by a passenger when the vehicle is used for providing a ride service. Alternatively the mobile computing device may be affixed to or contained in a package that shall have been entrusted to the driver for delivery in a case where the motor vehicle is used for package delivery. As further alternative, combinations of these systems may be employed. In each case the mobile computing device is in communication with a server operated by a company (the “monitoring company”) that (i) compensates the driver for the driving services or (ii) provides non-driving contractual services to the driver or (iii) both compensates the driver for the driving services and provides the non-contractual service to the driver. Examples of monitored drivers include those compensated by monitoring companies such as Uber, Lyft, and Gett providing ride services to passengers who access the services through a mobile application communicating with a server of the monitoring company. Other examples include drivers compensated by various delivery service companies, such as Grubhub for delivery of restaurant orders, or Amazon's division supporting independent contractor drivers, for package delivery, etc. In each case the driver is monitored in connection with a system for dynamically adjusting pricing of contractual services involving drivers, either as drivers or as consumers of contractual services, or as both drivers and consumers.

A “mobile computing device” is a portable computing device having a display (attached or unattached), an input system, a processor, a memory, and a two-way radio-frequency data communication capability, including, among other things, a smart phone, a suitably equipped tablet computer, a computer installed in a motor vehicle, smart watch, package tracking device, etc.

A mobile computing device is “carried” by a monitored driver if the device is generally installed for use in the motor vehicle, or carried by the driver for use by the driver, or carried by a passenger or affixed to a package, of which the use is being monitored.

A “set” includes at least one member.

A “non-driving contractual service” provided to monitored drivers via a program administered by an administrator server system includes, but is not limited to, any of motor vehicle insurance, health insurance, life insurance, disability insurance, workman's compensation insurance, home/renter's insurance, commercial liability insurance, a loan, umbrella insurance, a vehicle maintenance service (e.g., extended warranty, oil change, car wash/detailing, etc.), provision of a consumable, and a car buying service, but excludes any contractual arrangement between the monitoring company and any of its monitored drivers by which such driver is compensated by the monitoring company for services as a driver of a motor vehicle. Contractual services are not necessarily limited to services relating directly to vehicles or driving. For example, contractual services could include such things as homeowners insurance, renters insurance, mobile phone plans, etc. Thus, for example, a contractual service might include any type of insurance including property and casualty insurance or life and health insurance. In some cases, new types of contractual services (i.e., services that have not historically been provided through contractual relationships) may be created and brokered by the server system. Contractual services can be provided to other types of monitored entities (defined below) via a program administered by the server system.

A “service provider” is an organization providing a contractual service to a monitored driver.

An “information partner” is an organization having a data feed providing information relevant to the performance, behavior, or status of a monitored driver, and includes, but is not limited to, a social media company, such as Facebook, a credit reporting company, motor vehicle registry, law enforcement agency, background-checking agency, etc. Virtually any application running on or accessible by a mobile device can be an information partner.

A “consumable” is a product, such as gasoline, that is provided as a contractual service to a monitored driver who has subscribed to the service through the server system.

An “Applicant” is any person or entity (e.g., monitored driver, homeowner, small business, etc.) who has submitted an application for a contractual service to the Server System.

The “Base Rate” means the prevailing market rate for a product or service based on typical market criteria such as the insurance rate based on an insured's demographics and the property covered.

A “Client” is any person or entity who has contracted for a service, such as motor vehicle insurance, through the Server System.

A “monitored entity” is a person or business with respect to which there is an application, executing on a computing device associated with the person or business, in communication with a server operated by a monitoring company for purposes other than insurance and providing data to the server pertinent to performance of the person or business in some dimension other than insurance. A monitored driver is an example of one type of monitored entity. Other examples of monitored entities are discussed throughout this patent application.

A “Client Update Message” is any message related to a client (such as an insured) whether collected through direct input into the server system, over a wide area network from an endpoint of a named insured, or collected over a wide area network from other information systems, whether databases, social media feeds or messages from other server systems.

A “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “Computer Process” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single- or multi-processor) computer.

A “rebate” means any arrangement providing to a purchaser of goods or services a discount, financial incentive, or credit adjustment, regardless whether implemented by a cash payment or by a bookkeeping entry.

The “Initial Rebate Rate” means the rebate amount given for the first period of measurement.

A “Partner” may be an additional client (such as an additional insured), business partner, data provider, financial institution, government agency, insurance company, insurance brokerage, re-insurance company, social media company, or any other party lawfully authorized to receive data on an applicant or client, such as an insured, whether anonymized or not.

The “Net Policy Payment” is the Base Rate minus the Rebate Rate for any respective period of time.

“Rebate Rate” means the amount returned to an insured because of data collected and analyzed by system.

The “Current Rebate Rate” is the amount of the rebate for the current period, based on rebate programs being administered by the system.

The “Updated Rebate Rate” is the Rebate Rate for the upcoming period.

A “data feed” is data provided from a source to a recipient in the context of a service. A data feed can be provided from the source to the recipient in any of a variety of ways, such as by streaming data from the source to the recipient or by the recipient requesting data from the source. A data feed can include sensor data from a smartphone or other mobile communication device, such as, for example, location data from a GPS or other sensor, movement data from an inertial sensor such as an accelerometer or gyroscope, camera data from a camera, audio data from a microphone, etc.

The terms “period” and “periodically” can relate to any of various times or time intervals and are not necessarily limited to regular times or time periods. Thus, for example, an action done “periodically” can be done once or can be done many times, can be done at any appropriate time or time interval (e.g., hourly, daily, weekly, monthly, etc.), or can be done on-demand or upon the occurrence or non-occurrence of a particular event. In some instances, a period can be determined by any party involved in a transaction.

Where appropriate, the term “product” can include a service and the term “service” can include a product. For example, a product eligibility service of certain embodiments may determine eligibility for a service (e.g., motor vehicle insurance, which may be considered a “product” provided by an insurance company), and a service provider of certain embodiments may provide a product (e.g., a consumable, which may be considered a “service” of the provider).

Embodiments of the present invention provide a computer system (referred to herein as the “administrator server system” or simply the “server system”) configured to administer a program providing a contractual service under terms that are dynamically updated based on information from any of a variety of data feeds. Some exemplary embodiments are described herein in the context of providing property and casualty insurance to monitored drivers under terms that are updated based on driver performance and other information, although it should be noted that various alternative embodiments can additionally or alternatively provide other types of contractual services to other types of persons or entities under terms that are dynamically updated based on other types of information. In one embodiment, the server system automatically administers insurance and rebate programs for a population of monitored drivers based on contemporaneous data feeds from various rebate partners. Such rebates are generally used to reward or incentivize various types of behaviors of the drivers and can be used to reduce automobile insurance premiums paid by drivers. Without limitation, rebate partners can include rideshare companies (e.g., Uber, Lyft, Gett, etc.), insurance companies, companies that provide delivery services (e.g., restaurants, supermarkets, package delivery companies, online retailer, etc.), fuel companies, advertising companies (e.g., for placement or display of advertisements in vehicles or for driving customers to or past advertising locations such as stores or billboards), or any other type of partner that would like to provide rebates to the population of drivers. When a rideshare or other monitoring company acts as a rebate partner, its role as rebate partner is distinct from its role as a monitoring company, in that the rebate is administered by the server system and not by the monitoring company per se.

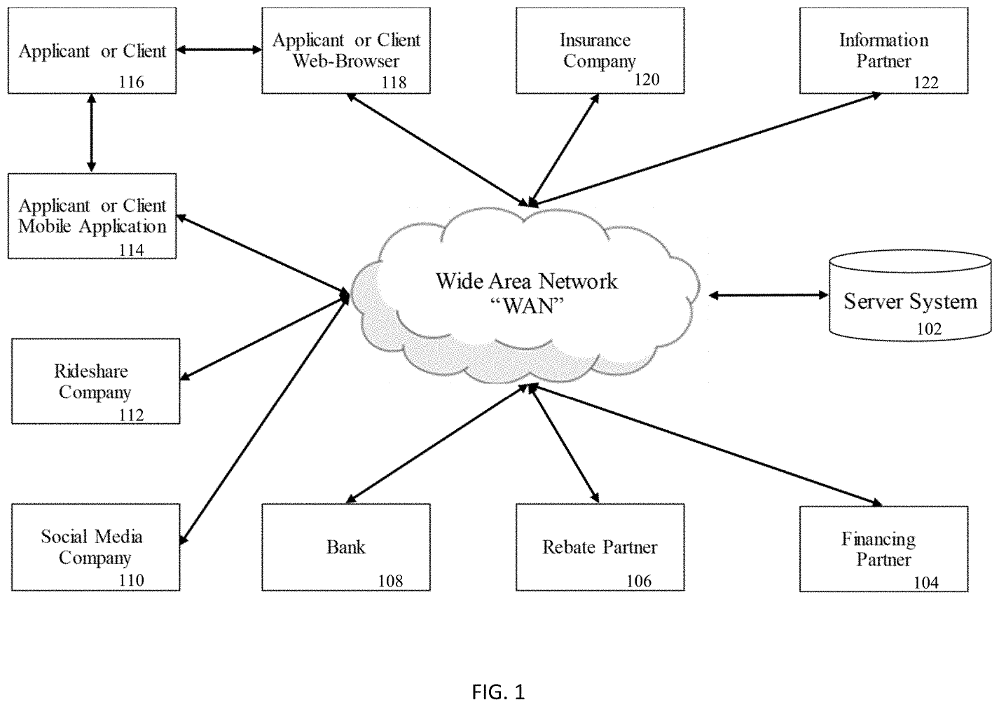

FIG. 1 is a schematic diagram showing various types of entities that may be involved with insurance and rebate programs administered by an administrator server system 102, in accordance with an exemplary embodiment. Here, the server system 102 is in communication over a wide-area network such as the Internet and other communication systems with various financing partners 104, rebate partners 106, banks (or other financial institutions including non-bank lenders) 108, social media companies 110, other information partners 122, rideshare companies 112, insurance companies (and reinsurance companies) 120, and applicants/clients 116 (through client web-browser 118 or mobile application 114). Additionally, there may also be other types of entities, such as service provider partners (not shown), including loan service providers, tax preparation service providers, and driver assistance providers.

The applicants/clients 116 generally interact with the Server System 102 via a mobile application 114 or web browser 118 running in a client device, which may be, for example, a mobile computing device such as a smartphone. The Server System 102 can obtain various types of information about or from the applicants/clients 116 either directly (e.g., via the mobile application 114 or web browser 118) or indirectly (e.g., reported to the Server System 102 via other sources), such as, for example, identification information, location information, or movement information, to name but a few. Any of the identified entities can provide data feeds to the Server System 102, including, without limitation, data feeds containing data from mobile computing devices of the applicants/clients 116 (e.g., including sensor data).

As mentioned above, rebate partners 106 can include rideshare companies 112, insurance companies 120, companies that provide delivery services (e.g., restaurants, supermarkets, package delivery companies, online service providers, etc.), fuel companies, advertising companies (e.g., for placement or display of advertisements in vehicles or for driving customers to or past advertising locations such as stores or billboards), or any other type of partner that would like to provide rebates to the population of drivers. Thus, in some cases, a particular entity, such as a rideshare company or insurance company, can take on multiple roles in the system such as both an information partner and a rebate partner.

The server system 102 can obtain information from any of a variety of information partners 122. (The term “information partner” is defined above.) In some cases, a particular entity may take on multiple roles in the system such as both an information partner 122 and a service provider.

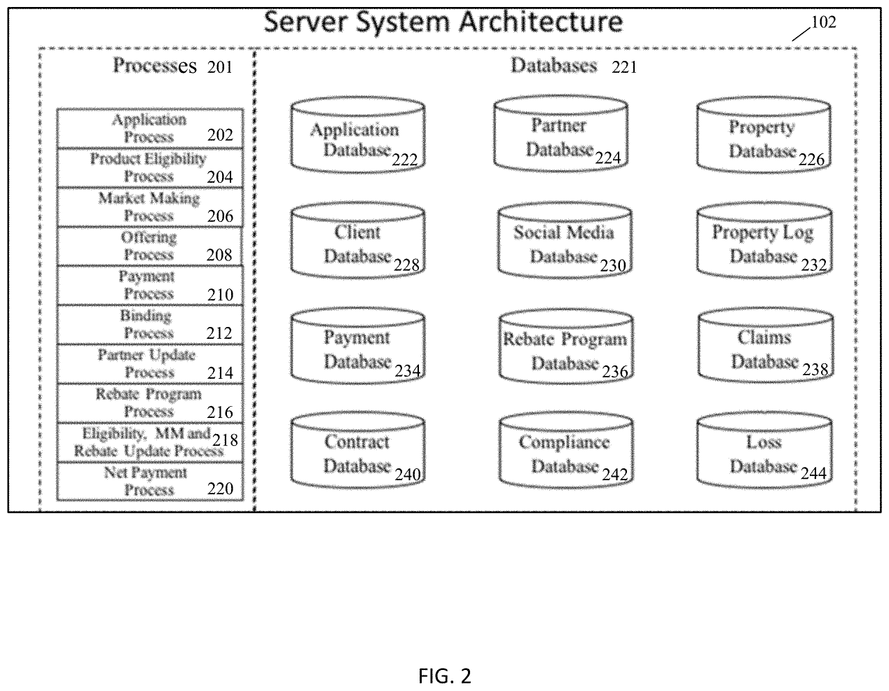

FIG. 2 is a schematic diagram showing various elements of the Server System 102, in accordance with an exemplary embodiment. Here, the Server System 102 includes various computer processes 201 including some or all of an application process 202, a product eligibility process 204, a market making process 206, an offering process 208, a payment process 210, a binding process 212, a partner update process 214, a rebate program process 216, an eligibility, market making, and rebate update process 218, and a net payment process 220. Examples of these processes are described in more detail below. The Server System 102 also includes various databases 221 stored in tangible, non-transitory media including, in this example, an application database 222, a partner database 224, a property database 226, a client database 228, a social media database 230, a property log database 232, a payment database 234, a rebate program database 236, a claims database 238, a contract database 240, a compliance database 242, and a loss database 244. Depending on the traffic and loads experienced by the server system 102, there may be multiple instances of various components for purposes of load balancing and system organization.

The following is an overview of the various processes, in accordance with an exemplary embodiment. The processes are discussed in more detail below.

Application process 202—collect the necessary information to apply for a product or service provided through the server system.

Product Eligibility process 204—determine whether or not an applicant is eligible for an applied for product or service. In the context of insurance, the Product Eligibility process 204 may include an underwriting process to determine whether an individual can be insured and, if so, under what policy and at what price. Market making process 206—process that re-determines eligibility and determines the market rate for a product or service.

Offering process 208—the process that delivers an offer of a product or service to an applicant with a Base Rate based on a market-making process and Initial Rebate Rate based on rebate programs available.

Payment process 210—process that bills and collects payments such as a down payment to bind a contract such as an insurance policy or a net rate payment due based on the Base rate and Rebate rate.

Binding process 212—process that confirms the applicant's acceptance, the provider's confirmation and payments necessary to enter into and bind a contract such as an insurance policy.

Partner update process 214—process by which the server system requests an update from a partner or by which a partner updates the server system based on business requirements.

Rebate program process 216—process that inputs the terms and conditions of a rebate program into the system.

Eligibility, Market Making and Rebating Update process 218—process that re-determines a client's eligibility for a product or service, the current market rate or Base Rate for that product or service, and an updated Rebate Rate based on rebate programs available.

Net payment process 220—the process that calculates the net payment due based on the Base Rate less Rebate Rates applicable.

The following is an overview of the various databases, in accordance with an exemplary embodiment.

Application Database 222—includes applicant information, property information, and information acquired by interested parties whether submitted by the applicant, collected through agreement or publicly available for the purposes of evaluating an applicant.

Client Database 228—includes any data to maintain a contractual relationship including account data, contact information, demographic information, moving violation data, credit score data; has links or references to all other databases.

Payment Database 234—includes records of Base Rates, Rebate Rates, Net Policy Payments and payment consideration from or on behalf of the client; has links or references to the Client, Contract, Partner, Rebate Program, Compliance and Claims Databases.

Contract Database 240—includes contract types and terms as well as the costs of the various components of the contract, the sum of which equals the Base Rate for the period of time for which each contract is effective; has links or references to the Application Database, Client Database, Payment Database, Partner Database, Rebate Program Database, Compliance Database, Property Database, Property Log Database, Claims Database and Loss Database.

Partner Database 224—includes vital information on partners, including the business relationship; has links to the Client Database, Payment Database, Contract Database, Social Media Database, Rebate Program Database, Compliance Database, and Property Database.

Social Media Database 230—data sourced from individuals through social media and other information accounts pertaining to a client, and in particular comments and ratings pertaining to an client such as an insured and/or the property insured; has links or references to the Application Database, Client Database, Partner Database, and Compliance Database.

Rebate Program Database 236—includes data inputted concerning a rebate program, including the terms of the rebate program whether measured by time, distance, social media feedback, financial metrics, partner incentives, promotional discounts, etc.; has links to the Application Database, Client Database, Payment Database, Contract Database, Partner Database, Social Media Database, Compliance Database, Property Database, Property Log Database, Claims Database and Loss Database.

Compliance Database 242—includes all data necessary or links to all data necessary to remain compliant with partner programs, rebate programs, government regulations or internal controls; has links to the Application Database, Client Database, Payment Database, Contract Database, Partner Database, Social Media Database, Rebate Program Database, Property Database, Property Log Database, Claims Database and Loss Database.

Property Database 226—data concerning property that relates to a contract such as property related to an insurance policy; for an automotive insurance policy, it would include make, model, mileage, VIN, color, and pictures of the property; has links or references to the Application Database, Client Database, Contract Database, Partner Database, Compliance Database, Property Log Database, Claims Database and Loss Database.

Property Log Database 232—data concerning the use of the insured property; for an automobile this could include mileage logs, trip information, location information and vehicle data such as speed, fuel levels, telematics etc.; has links or references to the Compliance Database, Property Database, and Claims Database.

Claims Database 238—record of claims submitted, adjudicated, paid or denied; has links or references to the Client Database, Contract Database, Partner Database, Compliance Database, Property Database, Property Log Database, and Loss Database.

Loss Database 244—record of losses and claims against the insured or the insured property; has links or references to the Application Database, Client Database, Contract Database, Partner Database, Compliance Database, Property Database, Property Log Database, and Claims Database.

Generally speaking, the Server System 102 will assign or maintain a unique user ID (also referred to herein as a “token”) for each driver of the population of drivers. For example, a particular driver might drive for one or more rideshare services, make deliveries for one or more delivery services, buy gas from one or more fuel companies, have insurance through one or more insurance companies, have auto loans through one or more loan companies, etc., and therefore the driver may be associated with different user IDs for each of these different services. Thus, in certain exemplary embodiments, the Server System 102 maintains a database (e.g., in the form of a cross-referencing table or database structure) that correlates the various user IDs associated with each driver. Among other things, this correlation database allows the Server System 102 to match information from various sources (e.g., data feeds and other sources) with the appropriate driver. For example, a rideshare service might report that driver ID 12345 made 6 trips today, and the Server System 102 can use the correlation database to match driver ID 12345 with the appropriate driver in the Server System 102 to determine if that driver should receive a bonus. Likewise, a social media service might have a trip experience posted that matches to the driver that performed the trip; the correlation database would match the social media post to the driver log.

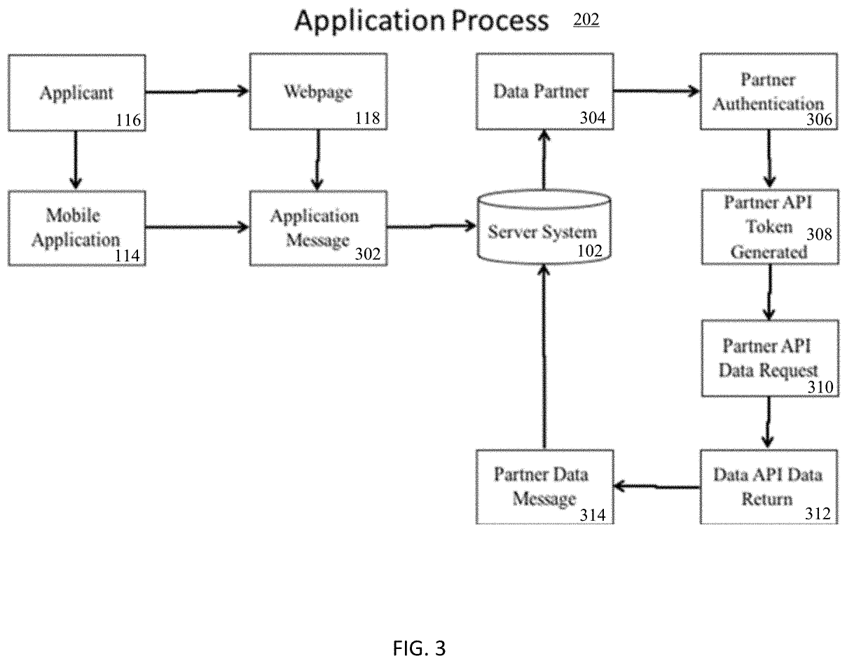

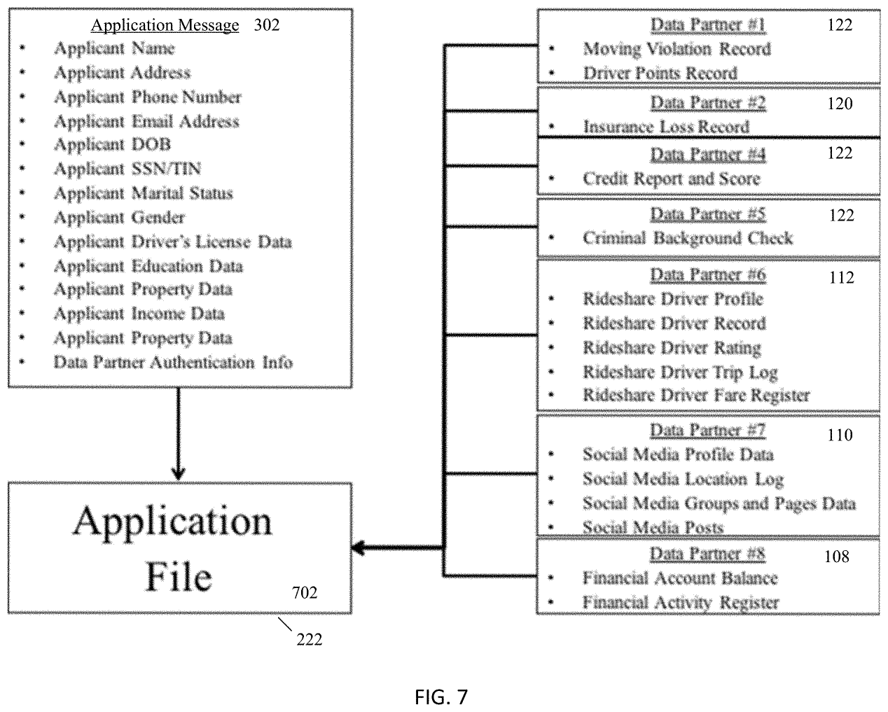

FIG. 3 is a schematic diagram demonstrating application process 202 in which an applicant 116 applies to become a member of the population of drivers who are eligible for insurance and/or rebates, in accordance with an exemplary embodiment. Here, the applicant 116 prepares an application via a user interface of the mobile application 114 or web browser 118, which sends an application message 302 to the Server System 102. As shown in FIG. 7, the application message 302 may contain such information as the applicant name, applicant address, applicant phone number, applicant email address, applicant date of birth (DOB), applicant social security number (SSN) or tax identification number (TIN), applicant marital status, applicant gender, applicant driver's license data (e.g., license number, state of issuance, expiration date, restrictions, etc.), applicant education data, applicant property data (data regarding one or more automobiles owned by the applicant or to be used by the applicant in providing driving services), applicant income data, data partner authentication information (to be used to later authenticate in block 306 and collect data from partners), and perhaps other types of data such as languages spoken, religious preferences, etc. In block 304, the Server System 102 receives data relating to the driver from the data feeds of various data partners. As shown in FIG. 7, the Server System 102 may receive data from data partners such as, for example, motor vehicle registries, insurance companies, credit reporting agencies, background checking agencies, rideshare companies, social media companies, and financing companies. Each partner may authenticate the driver in block 306, generate a provider-specific token for the driver in block 308, receive a request for data from the Server System 102 via a partner API in block 310, and provide a data message 314 to the Server System via the partner API in block 312. Depending on the particular embodiment, there may be multiple instances of the application process in order to accommodate a range of products and services as well as for load balancing.

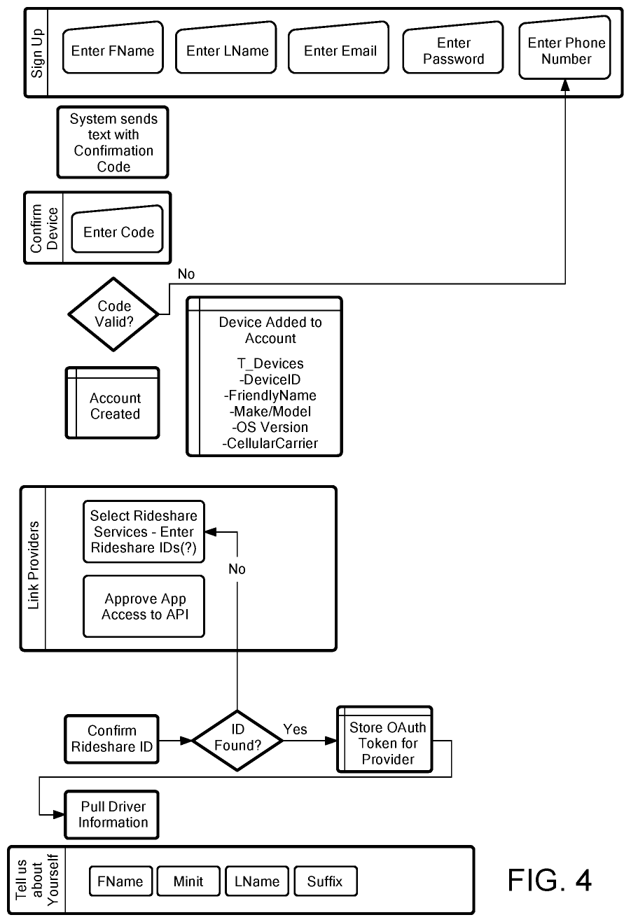

FIG. 4 is a schematic diagram showing a set of workflows that onboard and validate a new potential client by inputting, either through a website or a mobile application, a client's first name, last name, email address, password and phone number. The system then sends a confirmation code to the mobile phone which the user then enters into the website or mobile application to validate. Once this code is validated, the account is created and additional information such as the characteristics of the mobile account are added to the account. Once a valid account is created, then the user selects those rideshare partners he/she is affiliated with and connects them to the server system through giving access to the rideshare APIs. Once the potential client is validated as a rideshare driver, then in this example, the user can provide additional information about themselves and begin the insurance application process.

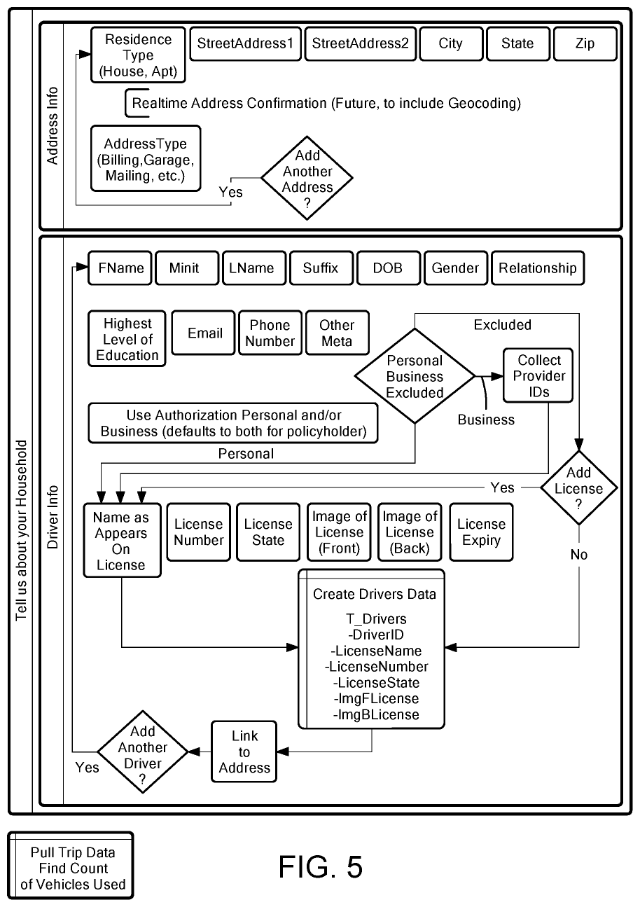

FIG. 5 is a schematic diagram demonstrating how a potential client, with a valid account, can provide all the details necessary about themselves and their household as part of an insurance application. In this figure, the user provides their household address(es) (street, city, state, and zip). Then, the potential client submits those members of the household that are drivers or potential drivers and whether or not such drivers would be using vehicles for personal, business or mixed use. Information on each driver is collected including license information, date of birth, gender, marital status, education level and other information.

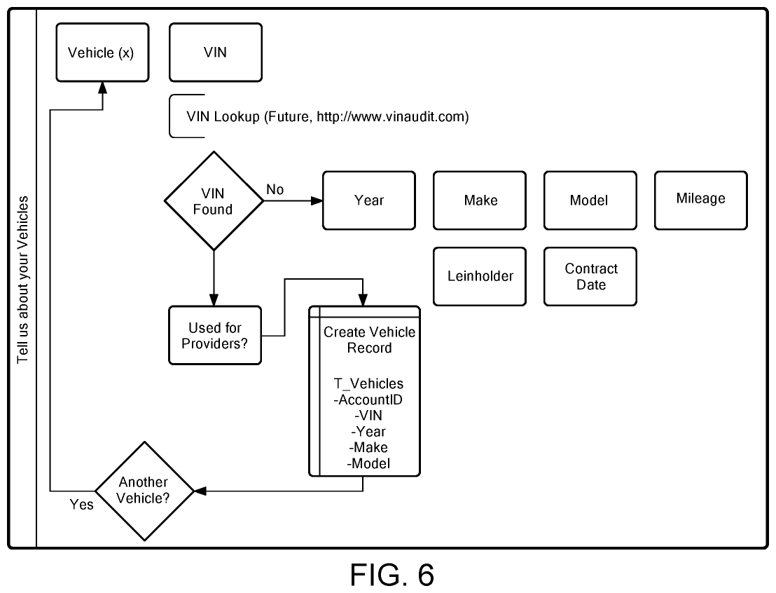

FIG. 6 is a schematic diagram showing how the potential client can enter in their vehicle information, including vehicle identification number (VIN), year, make, model, mileage, lienholders (if any), and whether or not the vehicle is used for rideshare (or other commercial use).

FIG. 7 is a schematic diagram showing some types of information stored in an application file 702 in the application database 222, in accordance with an exemplary embodiment. Among other things, the applicant message 302 is stored in the application file 702 along with information gathered from various information partners 122. Here, the information partners 122 include a motor vehicle registry that can provide such information as moving violation records and driver point records, an insurance company 120 that can provide such information as insurance loss records, a credit reporting agency that can provide such information as credit reports and scores, a background checking agency that can provide such information as criminal background check reports, a rideshare company 112 that can provide various types of information about the driver, a social media company 110 that can provide various types of information about the driver, and a financial partner 108 that can provide such information as financial account balances and financial activity registers.

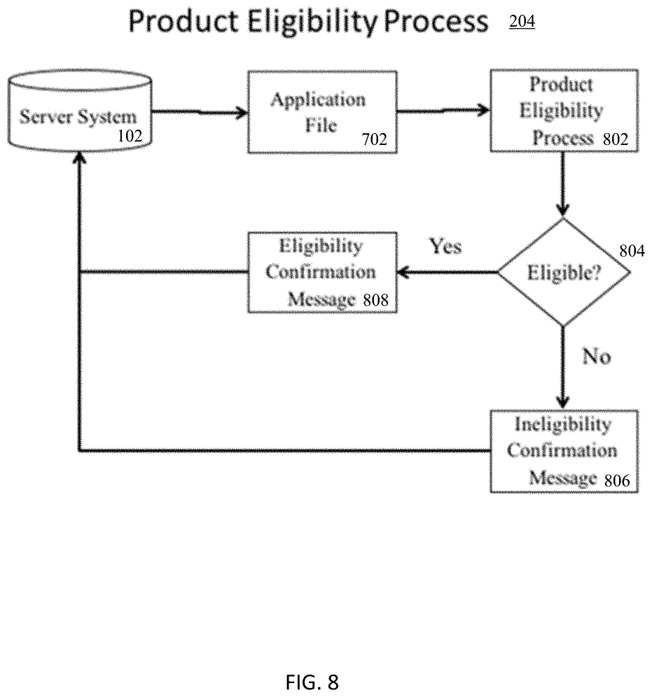

FIG. 8 is a schematic diagram demonstrating product eligibility process 204, in accordance with an exemplary embodiment. Here, the Server System 102 uses the information in the application file 702 to assess eligibility of the applicant 116, in block 802. If the applicant 116 is eligible for the product (YES in block 804), then the Server System 102 sends an eligibility confirmation message to the applicant 116, in block 808. If, however, the applicant 116 is not eligible for the product (NO in block 804), then the Server System 102 sends an ineligibility confirmation message to the applicant 116, in block 806.

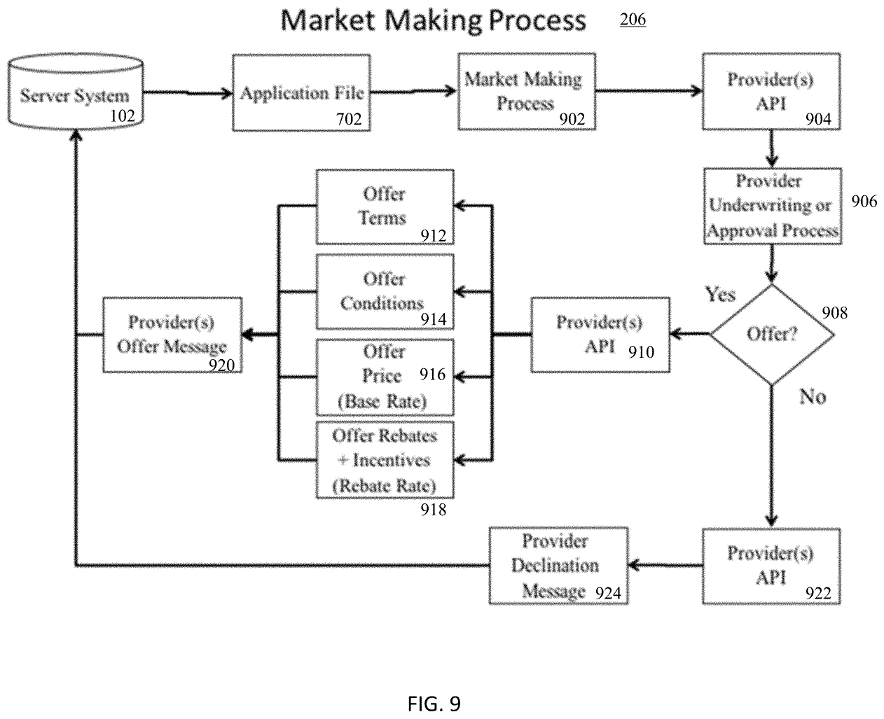

FIG. 9 is a schematic diagram demonstrating market making process 206, in accordance with an exemplary embodiment. Here, the Server System 102 uses the information in the application file 702 to identify potential providers that might interested in establishing a relationship with the applicant 116, in block 902. The Server System 102 contacts a provider via a provider API, in block 904. The provider performs an underwriting or approval process to decide whether to make an offer to the applicant 116, in block 906. If the provider decides to make an offer to the applicant 116 (YES in block 908), then the provider provides to the Server System 102, via the provider API in block 910, an offer message 920 including relevant information for the offer, such as, for example, offer terms 912, offer conditions 914, offer price 916, and offer rebates and incentives 918. If, however, the provider decides not to offer to the applicant 116 (NO in block 908), then the Server System 102 sends a Provider Declination Message through the Provider API 922 to the applicant 116, in block 924.

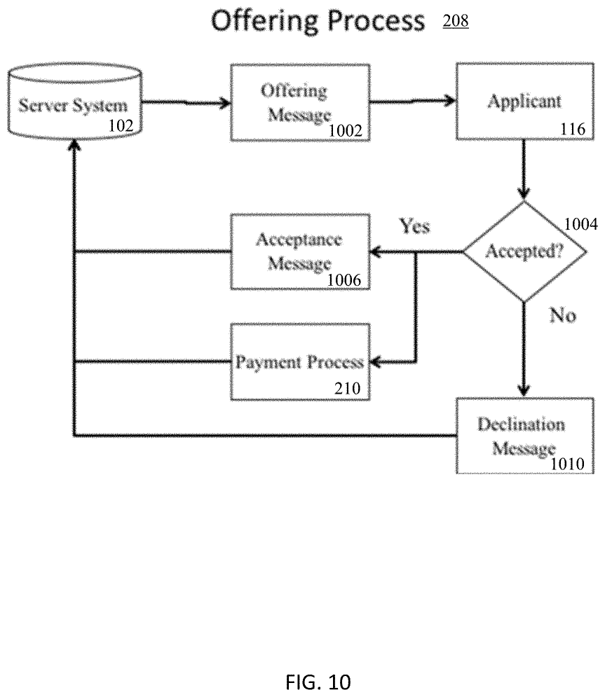

FIG. 10 is a schematic diagram demonstrating offering process 208, in accordance with an exemplary embodiment. Further to the market making process 206, the Server System 102 sends an offer message 1002 to the applicant 116, typically including information from the offer message 920 received from the provider. If the applicant 116 accepts the offer (YES in block 1004), then the applicant 116 generally sends an acceptance message 1006 to the Server System 102 and optionally engages in a payment process 210 with the Server System 102. If, however, the applicant 116 declines the offer (NO in block 1004), then the applicant 116 generally sends a declination message 1010 to the Server System 102.

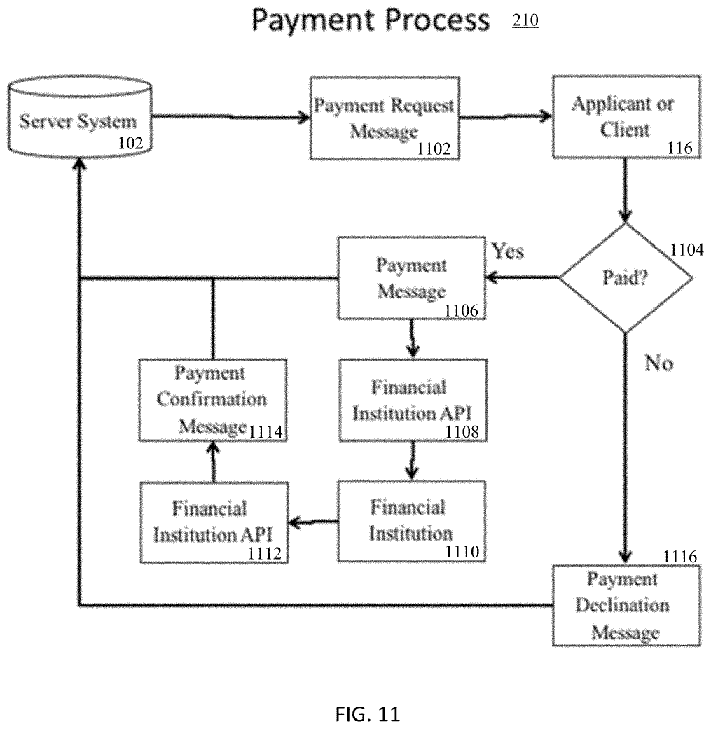

FIG. 11 is a schematic diagram demonstrating payment process 210, in accordance with an exemplary embodiment. The Server System 102 sends a payment request message 1102 to the applicant/client 116. The applicant/client 116 decides whether or not to make the payment. If the applicant/client 116 decides the make the payment (YES in block 1104), a payment message 1106 is sent to the appropriate financial institution 1110 via the financial institution API in block 1108, and upon completion of the payment, the financial institution 1110 sends a payment confirmation message 1114 to the Server System 102 via the financial institution API in block 1112. If the applicant 116 decides not to make the payment (NO in block 1104), a Payment Declination Message 1116 is sent to Server System 102.

FIG. 12 is a schematic diagram demonstrating binding process 212, in accordance with an exemplary embodiment. Here, the Server System 102 sends a binding request message 1202 to a provider 1206 via the provider API in block 1204. Upon issuance of the binder, the provider 1206 sends a contract binding message 1210 to the Server System 102 via the provider API in block 1208.

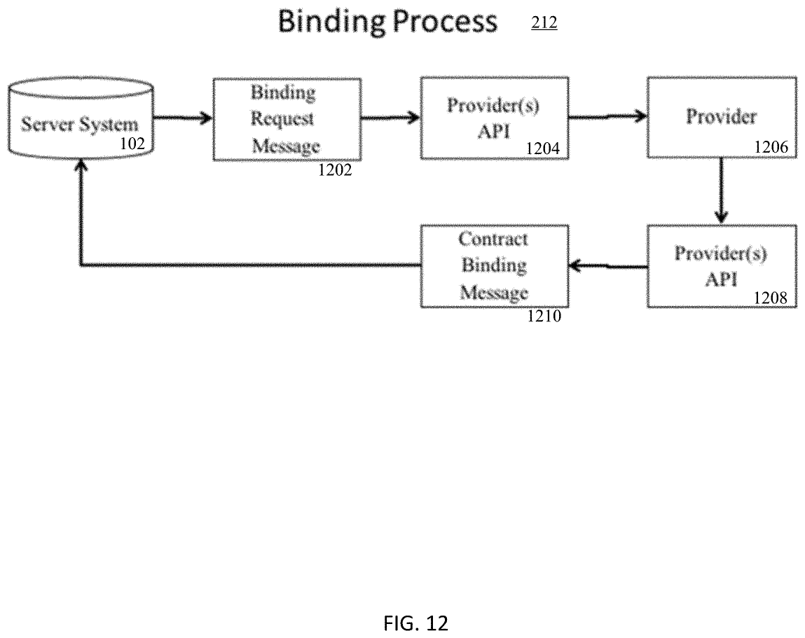

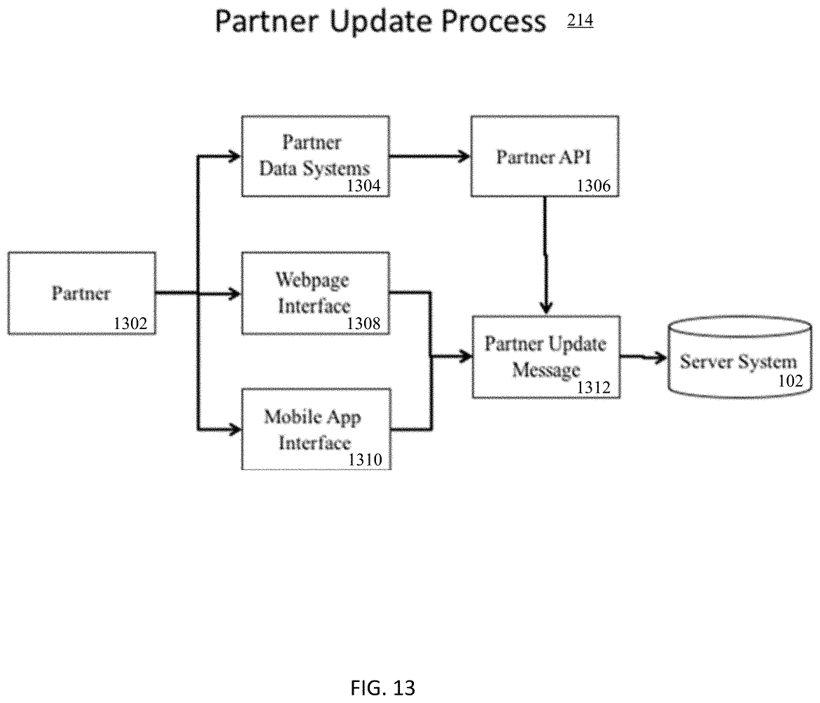

FIG. 13 is a schematic diagram demonstrating partner update process 214, in accordance with an exemplary embodiment. The partner update process 214 may be used for the Server System 102 to obtain data from a partner relating to the driver, such as, for example, reports of trips driven by the driver, claims made against the driver (e.g., insurance claims such as for an accident), or violations by the driver (e.g., speeding ticket or other moving violation, etc.). Here, a partner 1302 sends a partner update message 1312 to the Server System 102 via a mobile app interface 1310, a web interface 1308, or a partner API 1306 coupled to a partner data system 1304. The Server System 102 uses the information in the partner update message 1312 to update the appropriate databases 221. The partner API 1306, which may be bi-directional, may additionally or alternatively include a file-transfer-process (FTP), as well as a messaging process either in batch or streaming.

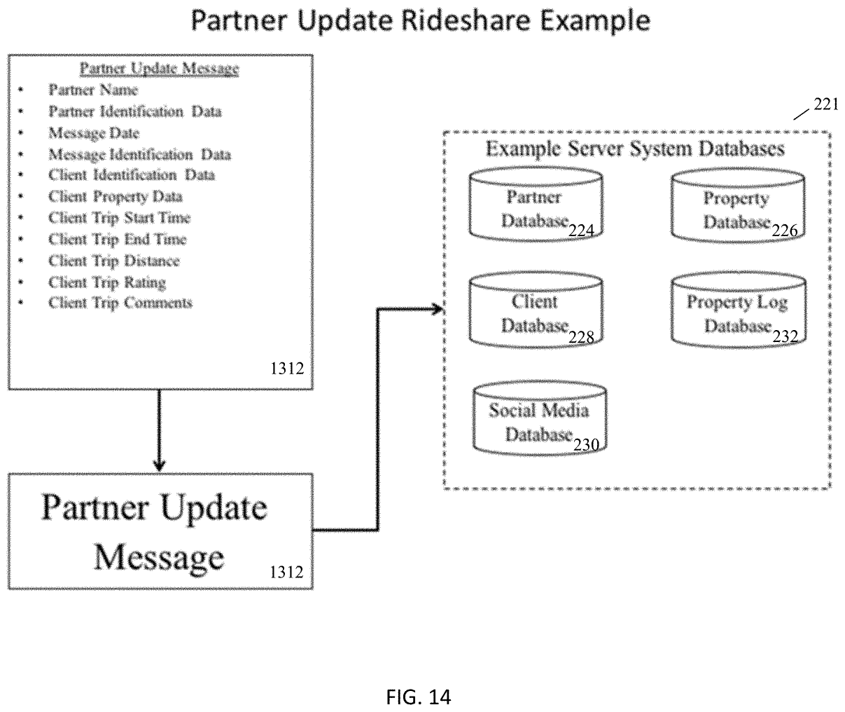

FIG. 14 is a schematic diagram demonstrating partner update process 214 for a rideshare example, in accordance with an exemplary embodiment. Here, the partner update message 1312 includes information such as, for example, partner name, partner identification data, message date, message identification data, client identification data, client property data, client trip start time, client trip end time, client trip distance, client trip rating (e.g., a rating from a passenger), and client trip comments. The Server System 102 can use the information from the partner update message 1312 to update databases 221 such as the partner database 224, the property database 226, the client database 228, the property log database 232, and the social media database 230.

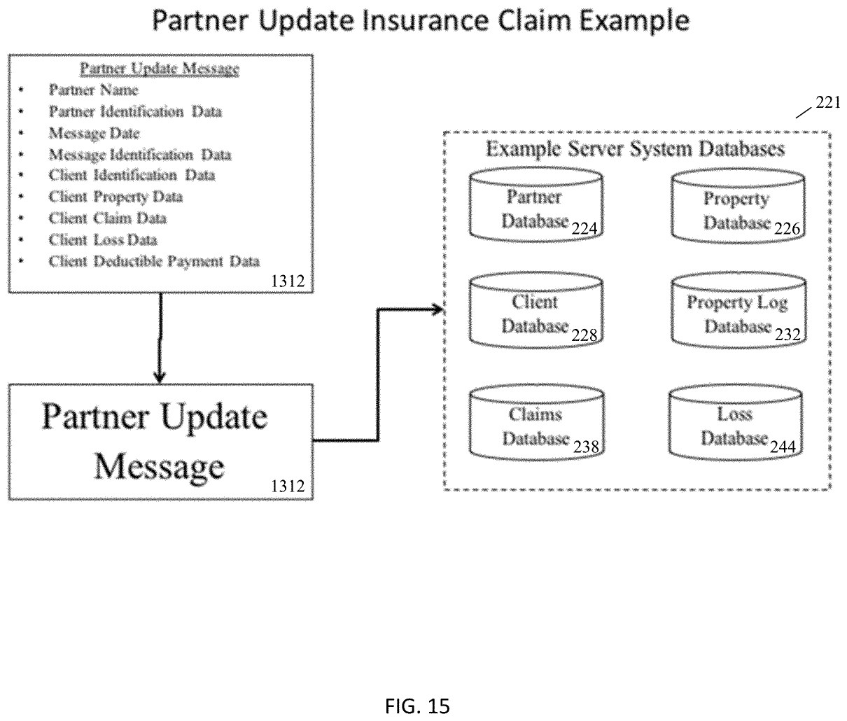

FIG. 15 is a schematic diagram demonstrating partner update process 214 for an insurance claim example, in accordance with an exemplary embodiment. Here, the partner update message 1312 includes information such as, for example, partner name, partner identification data, message date, message identification data, client identification data, client property data, client claim data, client loss data, and client deductible payment data. The Server System 102 can use the information from the partner update message 1312 to update databases 221 such as the partner database 224, the property database 226, the client database 228, the property log database 232, the claims database 238 and the loss database 244.

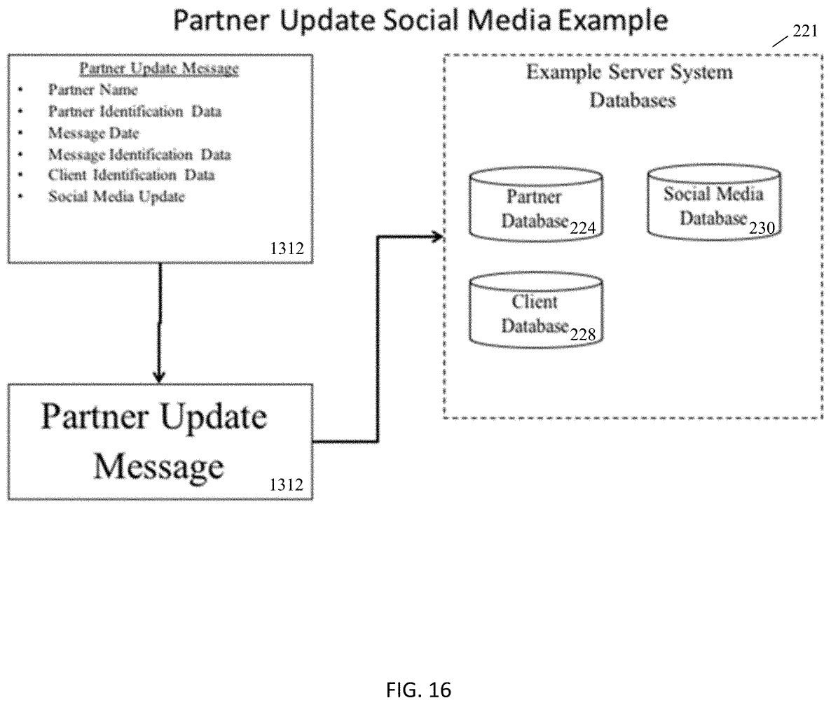

FIG. 16 is a schematic diagram demonstrating partner update process 214 for a social media example, in accordance with an exemplary embodiment. Here, the partner update message 1312 includes information such as, for example, partner name, partner identification data, message date, message identification data, client identification data, and social media update data. The Server System 102 can use the information from the partner update message 1312 to update databases 221 such as the partner database 224, the client database 228, and the social media database 230.

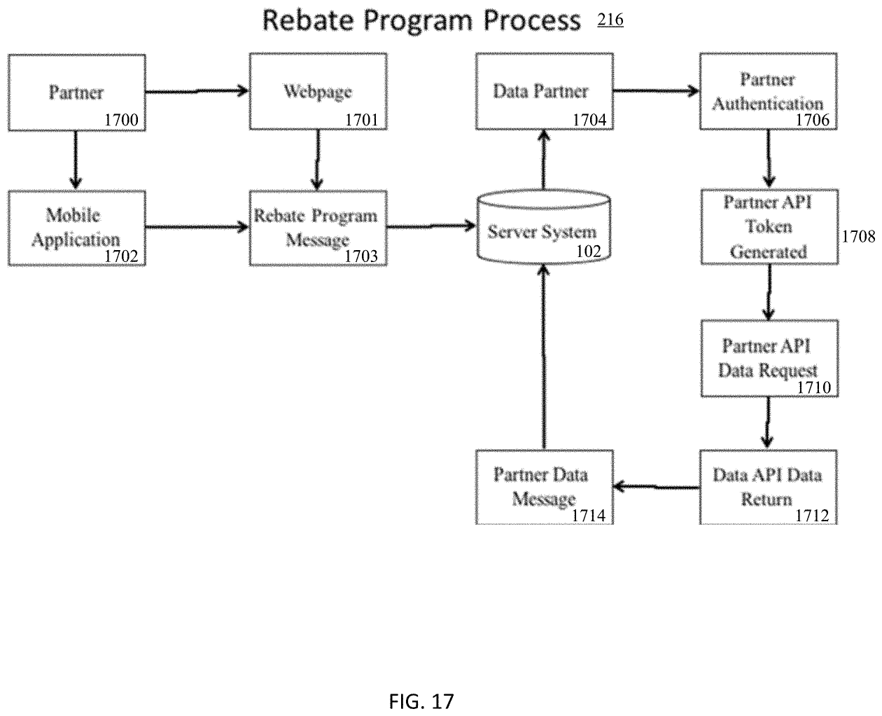

FIG. 17 is a schematic diagram demonstrating rebate program process 216 for setting up a rebate program, in accordance with an exemplary embodiment. Here, a partner 1700 prepares a rebate program via a mobile application 1702 or web browser 1701, which sends a rebate program message 1703 to the Server System 102. As shown in FIG. 18, the rebate program message 1703 may contain such information as the sponsor name, sponsor address, sponsor phone number, sponsor email address, sponsor point of contact, sponsor social security number (SSN) or tax identification number (TIN), sponsor financial information (e.g., a bank account from which rebates can be withdrawn), rebate program name, rebate program number, rebate program eligibility dates, rebate program criteria, rebate program economics, rebate program documentation requirements, and rebate program terms/conditions. In block 1704, the Server System 102 receives data relating to the partner 1700 from the data feeds of various data partners. Each data partner may authenticate the partner 1700 in block 1706, generate a provider-specific token for the partner 1700 in block 1708, receive a request for data from the Server System 102 via a partner API in block 1710, and provide a data message 1714 to the Server System via the partner API in block 1712.

FIG. 18 is a schematic diagram showing information from the rebate program message 1703 stored in a rebate program file 1802 in the rebate program database 236, in accordance with an exemplary embodiment. Information from the rebate program file 1802 also can be used to update other databases, such as the client database 228 and the partner database 224.

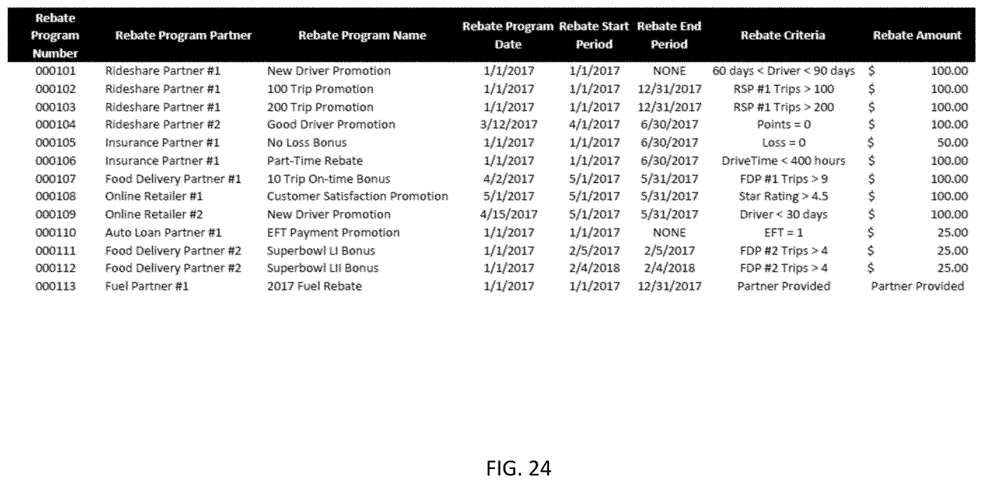

FIG. 24 is a schematic diagram showing a rebate program file 1802, in accordance with an exemplary embodiment. Here, each rebate program (numbered 000101 to 000113) includes the rebate program partner name, the rebate program name, the rebate program date (e.g., the date on which the rebate program was created), the rebate start date, the rebate end data, the rebate criteria, and the rebate amount. As shown, a rebate program can be open-ended, e.g., as indicated by a rebate end date of “NONE.” Also, as shown, a rebate program can be administered by a partner, in which case the rebate partner would provide information regarding any earned rebates to the Server System 102.

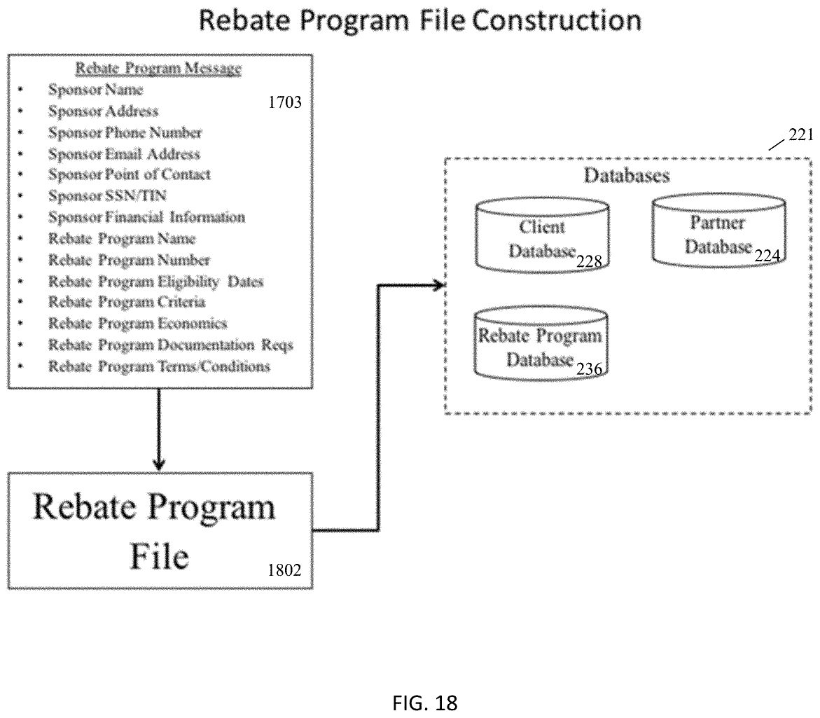

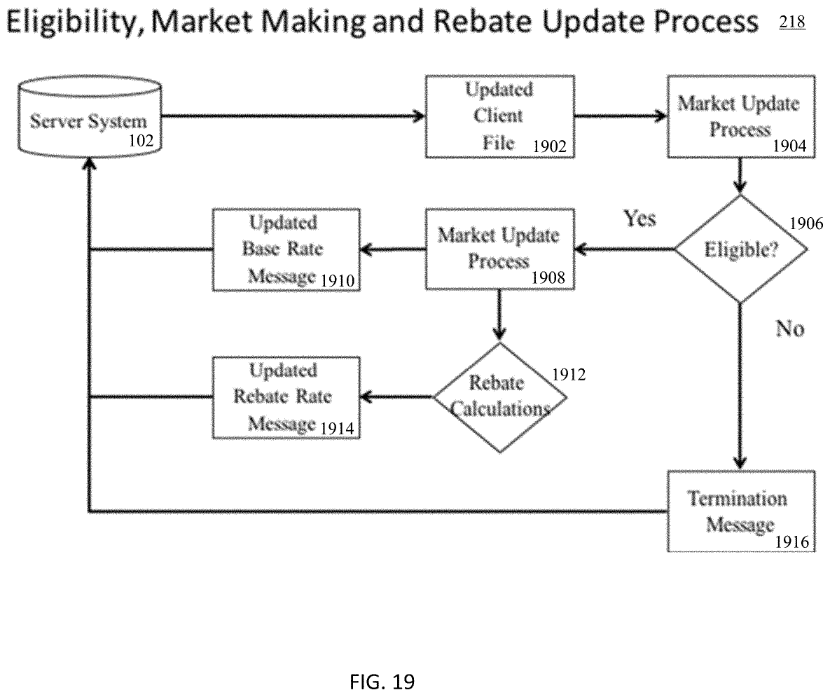

FIG. 19 is a schematic diagram demonstrating an eligibility, market making, and rebate update process 218, in accordance with an exemplary embodiment. Here, the Server System 102 processes an updated client file 1902 (e.g., as client updates become available, or at preset times such as daily, weekly, or monthly) to determine if the client has earned any rebates or is eligible for additional rebate programs. In block 1904, the Server System 102 performs a market update process similar to the market making process 206 to determine eligibility of the client for various rebate programs. If the applicant 116 is eligible (YES in block 1906), performs a Market Update Process 1908 and provides updated base rate information to the Server System 102 via updated base rate message 1910, performs rebate calculations in block 1912 as discussed in more detail below, and provides updated rebate rate information to the Server System 102 via updated rebate rate message 1914. If the applicant is not eligible (NO in block 1906), provides a Termination Message 1916 to the Server System 102.

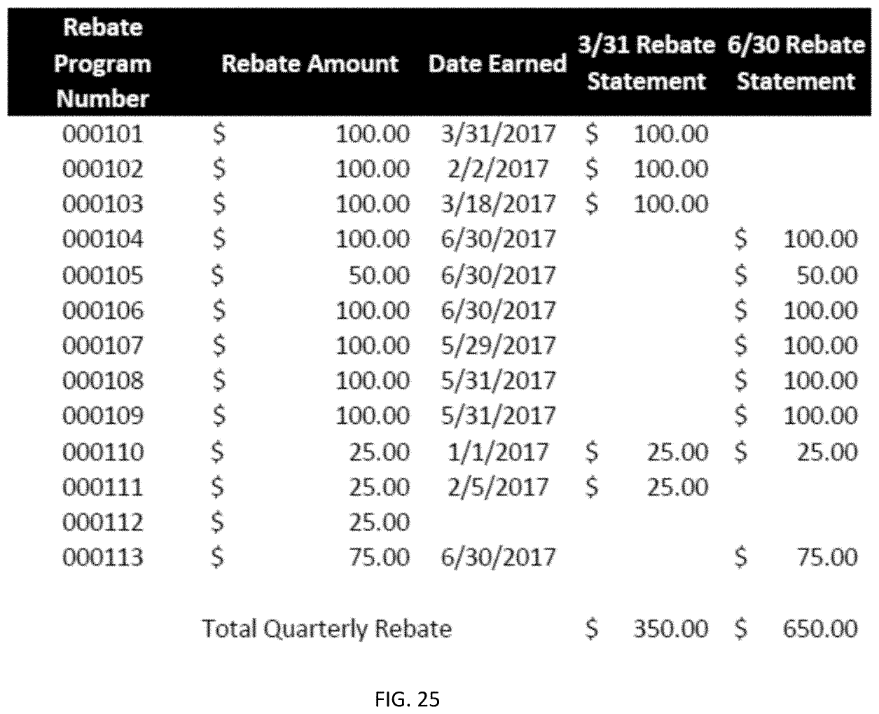

FIG. 25 is a schematic diagram providing first exemplary results from rebate calculations such as in block 1912 of FIG. 19 using the exemplary rebate program file 1802 of FIG. 24, in accordance with one exemplary embodiment. Here, a client earned $350.00 in rebates for the quarter ending March 31 and earned $650.00 rebates for the quarter ending June 30.

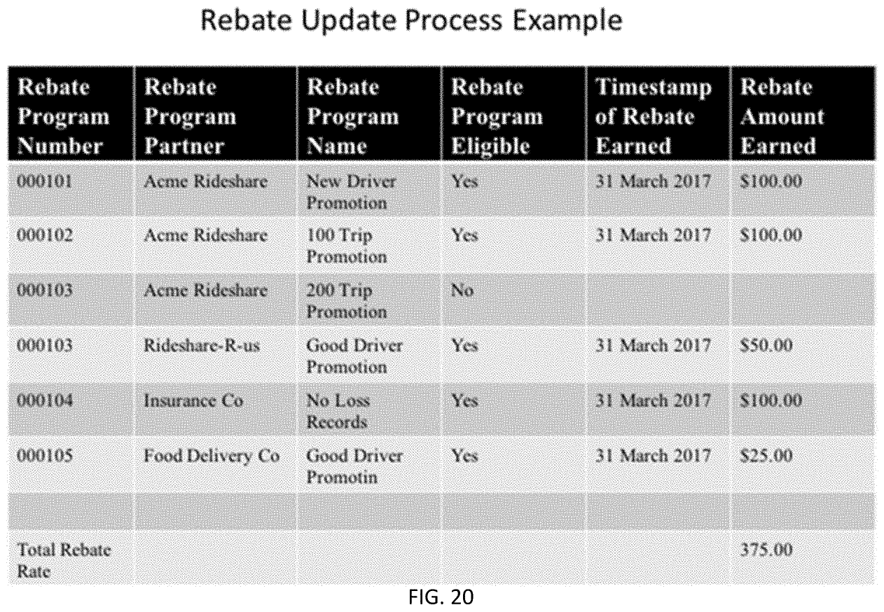

FIG. 20 is a schematic diagram providing second exemplary results from rebate calculations such as in block 1912 of FIG. 19, in accordance with one exemplary embodiment. Here, the client earned $375.00 in rebates.

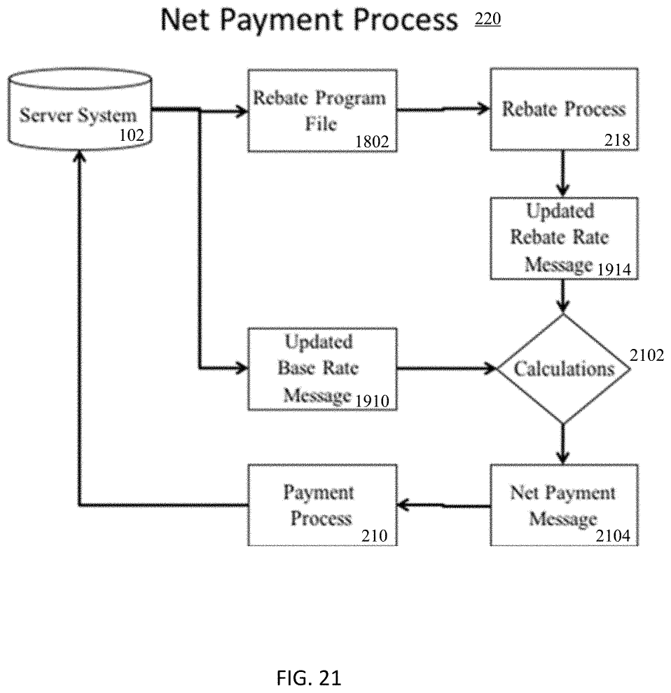

FIG. 21 is a schematic diagram demonstrating net payment process 220, in accordance with an exemplary embodiment. Here, the Server System 102 processes a rebate program file 1802 through a rebate process 218 to obtain an updated rebate rate message 1914 (e.g., rebates earned). The Server System 102 calculates a net payment due from the client based on the updated base rate information (e.g., how much the client would owe without rebates, e.g., for insurance premiums) through an Updated Base Rate Message 1910 and the rebates earned and recorded in the Updated Rebate Rate Message 1914 to calculate 2102 the net payment amount. The Server System 102 generates a net payment message 2104 including the net amount to be paid by the client and then performs a payment process 210.

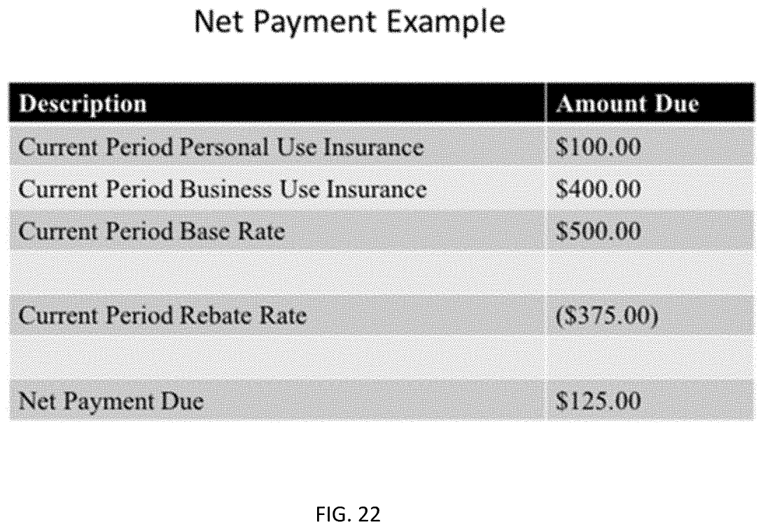

FIG. 22 is a schematic diagram providing an example of a net payment based on the results from the rebate calculations of FIG. 20, in accordance with one exemplary embodiment. Here, the client would have owed a current period base rate, before rebates, of $500 including $100 for personal use insurance and $400 for business use insurance. In this example, the client has earned a current period rebate rate of $375, resulting in a new payment owed of $125.

Using the example of FIG. 22, rebates and payments can be handled in any of a variety of ways. For example, without limitation, the server system may obtain the earned rebates of $375 from the various rebate partners and pay the $375 to the insurance company on behalf of the driver and either collect the remaining $125 from the driver and pay the $125 to the insurance company or direct the driver to pay the $125 directly to the insurance company.

In some embodiments, if the rebates earned by the driver exceed the current period base rate, the excess funds may be saved by the server system to be applied in a later period, used toward another contractual service, or refunded to the driver.

In order to incentivize drivers to perform, the server system may provide feedback (e.g., via text messages, a mobile app in communication with the server system, or other notification mechanism) regarding one or more rebates available to a driver and the driver's clients. For example, the server system may inform a driver that three more rides are needed to earn a particular rebate from a particular rebate partner, thereby incentivizing the driver to make three more rides.

In some embodiments, the server system can collect compensation for administering certain contractual services with rebates. For example, the server system may collect compensation from certain rebate partners (e.g., a monthly fee, a percentage of rebates earned, etc.). Similarly, the server system may collect compensation from certain contractual service providers (e.g., a fee for each insurance policy brokered).

It should be noted that embodiments may provide for reducing the amount of earned rebates under certain circumstances (e.g., reducing earned rebates by $5 for each negative review or late passenger pickup by the driver). In some cases, such reductions may be administered as a “negative rebate” within the context of the overall rebate administration. For example, a rebate partner may establish a rebate program in which the qualifying event (e.g., a negative review or late passenger pickup) earns a negative dollar amount. Typically, but not necessarily, reductions or negative rebates would be capped at the amount of the rebates earned from the program partner during a particular period.

In the context of incentivizing drivers and receiving compensation, or otherwise, the server system can be configured to run an auction or other program by which organizations (e.g., rebate partners, advertisers, etc.) can compete against one another for notifications provided by the server system to drivers. For example, the server system could provide a bidding process by which rideshare companies could compete to have their respective rebate incentives provided to a particular driver, e.g., to incentivize the driver to take on rides for a particular one of the rideshare companies. The server system can be configured to support dynamically-generated rebate programs that can be targeted to a set of drivers (which could include just one specific driver). For example, on a busy holiday weekend, a particular rideshare company could provide a targeted rebate to a specific driver or group of drivers to take on additional rides (e.g., $5 rebate per additional ride). Such a dynamically-generated rebate program could be targeted based on any of a variety of criteria, such as, for example, the location of a particular driver relative to the number and locations of people requesting rides.

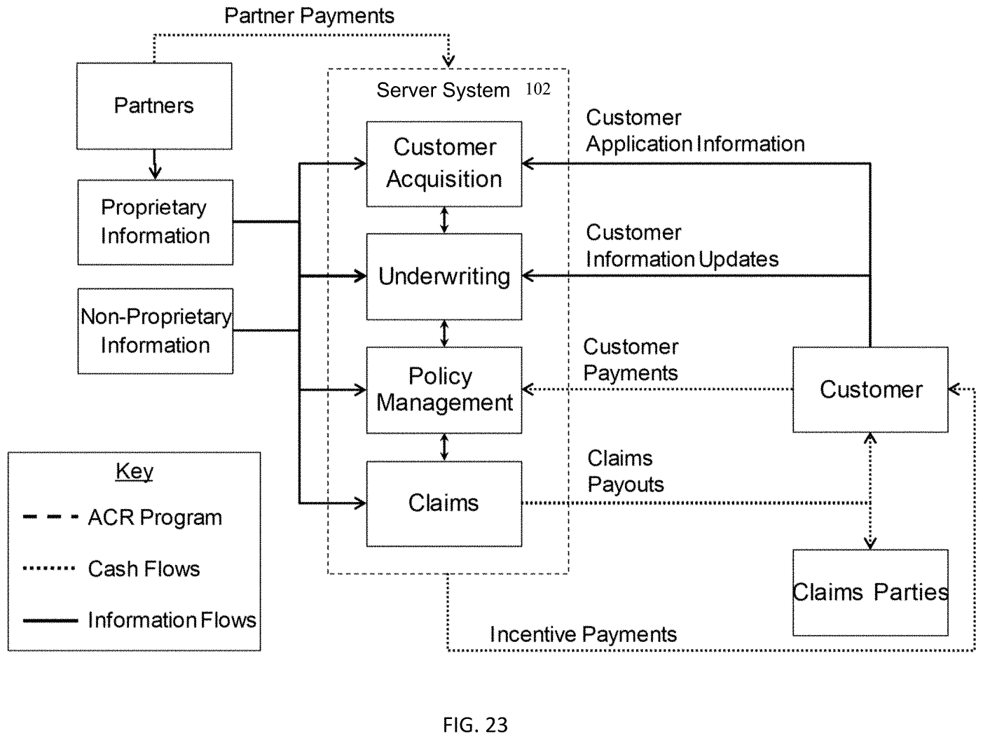

FIG. 23 is a schematic diagram of a system for administering insurance with rebate incentives, in accordance with an exemplary embodiment. The Server System 102 effectively brokers insurance arrangements for customers, and the Server System 102 can be involved with initial customer acquisition, insurance underwriting, insurance policy management, and claims processing. In this respect, the Server System 102 receives information of the types discussed above from customers as well as from various partners. As discussed above, partner payments associated with rebates earned by customers can be used to offset insurance premiums owed by the customers; additionally or alternatively, some of the partner payments can be used for claims payouts and/or for incentive payments made to the customers. The term “ACR Program” in FIG. 23 refers to the Automatic Customer Rebate program implemented in accordance with embodiments of the present invention.

The Server System 102 can be configured to perform various types of ancillary functions. Without limitation, the following are some examples of ancillary functions.

### Example 1

The Server System 102 may be configured to provide ancillary information to drivers, such as, for example, sending route information, traffic information, warnings (e.g., a message telling the driver to slow down if GPS information indicates that the driver is speeding), and other types of information, e.g., by text message or other communications. For example, without limitation, the Server System 102 may be configured to recommend routing that avoids typical dangerous intersections or to recommend routing that maximizes right turns.

### Example 2

The Server System 102 may be configured to provide ancillary incentives to drivers, such as, for example, notifying the driver that additional rebates can be earned such as by driving past a sponsored location (e.g., a billboard) to expose the passenger to the sponsored location, downloading specific apps, taking surveys, etc.

### Example 3

The Server System 102 may be configured to use the various types of information from the databases 221 for data mining and complex “big data” analysis with applications to individual drivers or groups of drivers (up to including the entire population of drivers) and also with application to partners and other entities.

### Example 4

For a particular driver, based on such things as the number of trips driven in a given day, the length of those trips, the distances of those trips, the locations of those trips, and other information, the Server System 102 might be configured to determine whether the driver has exceeded a predetermined maximum amount of driving or otherwise should take a rest. The Server System 102 may be configured to send a recommendation message to the driver to stop driving, and may include suggestions for where the driver might stop (e.g., a motel, restaurant, or coffee shop that provides discounts or rebates to members).

### Example 5

For a particular driver, based on such things as the number of trips driven over an extended period of time, the length of those trips, the distances of those trips, the locations of those trips, and other information, the Server System 102 may be configured to determine that maintenance may be needed on the vehicle (e.g., oil change, brakes, tires, etc.). The Server System 102 may be configured to send a recommendation message to the driver to get maintenance on the vehicle, and may include suggestions for where the driver might go for such maintenance (e.g., a nearby service station that provides discounts or rebates to members).

### Example 6

The Server System 102 may be configured to evaluate risk based on various criteria (e.g., driver location, pickup location, weather conditions, etc.). This information can be used, for example, to adjust insurance premiums, adjust rebates, etc. For example, life or health insurance premiums can be adjusted based on data relating to driving activities (e.g., collected from a ridesharing data feed) or data relating to personal activities (e.g., collected from a smart phone app). For example, life or health insurance premiums might be raised for drivers who drive in a high-crime areas with increased risk of being attacked, for drivers who exhibit other high-risk behaviors such as speeding or driving during early morning hours, for people who engage in high-risk activities such as skydiving, or for people who fail to engage in healthy activities such as exercise. Similarly, property insurance can be adjusted based on data relating to property risks. For example, property insurance premiums relating to a home used for lodging (e.g., Airbnb) might be adjusted based on the number of nights the home is used for lodging, whether the home has monitored security systems, how often a cleaning or security service visits the home (more visits might lower the risk of damage due to a water leak), or the amount of time the air conditioning is running (e.g., based on data received from a smart thermostat).

### Example 7

The Server System 102 may be configured to evaluate trends (e.g., drivers tend to avoid a particular city or area or tend to avoid making deliveries for certain companies). This information can be used, for example, to provide additional incentives for drivers to accept such trips, such as higher or more frequent rebates.

### Example 8

The Server System 102 may be configured to evaluate individual driver performance, such as, for example, propensity for speeding (e.g., determined based on GPS data from the driver's mobile device). This information can be used, for example, to warn or penalize the driver, e.g., by reducing earned rebates.

### Example 9

The Server System 102 may be configured to reward drivers and partners for helping to achieving network effects. For example, a driver could be rewarded for referring other drivers that register for unlimited car washes through a reward or rebate on their car wash expenses. Another example could be a similar structure for cellular phone service referrals.

### Example 10

A homeowner or lessee may be monitored by a peer-to-peer service like Airbnb, HomeAway, Booking or other service that brokers lodging accommodations to guests, much like a hotel or motel. In addition to property information, neighborhood statistics, and other basic information, these services also track correspondence and reviews. In addition to the information these services provide, often collected through smart phones, additional information can be collected to provide products and services to these shared providers of lodging. Examples of products and services include home insurance, home improvement loans, home repair services, security products/services, and other products/services needed by these shared home providers to operate their businesses. Such a homeowner or lessee can be a monitored entity.

### Example 11

An individual or business that provides skilled or unskilled labor, matched to clients through a similar peer-to-peer or shared brokerage service, such as a home repairman, computer technician, fitness coach/instructor, yoga instructor, medical provider, or other product/service that is provided through a shared service through a network also is constantly monitored through these networks. Such monitored data, as well as additional data, can be collected to provide insurance, cellular phone service, loans, and other things needed to conduct business. Such individual or business can be a monitored entity.

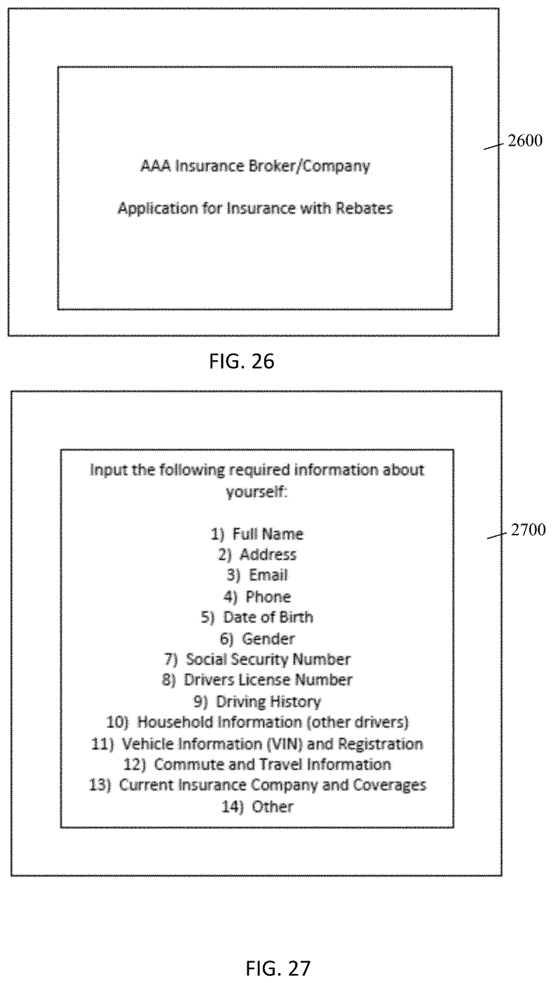

An exemplary user interface is now described with reference to FIGS. 26-41.

FIG. 26 is a schematic diagram showing an opening user interface screen 2600 in “wireframe” form for an applicant, such as a rideshare driver, to apply for insurance with rebates, in accordance with one exemplary embodiment.

FIG. 27 is a schematic diagram showing a user interface screen 2700 in “wireframe” form for the applicant to input data to generate an application for insurance with rebates, in accordance with one exemplary embodiment.

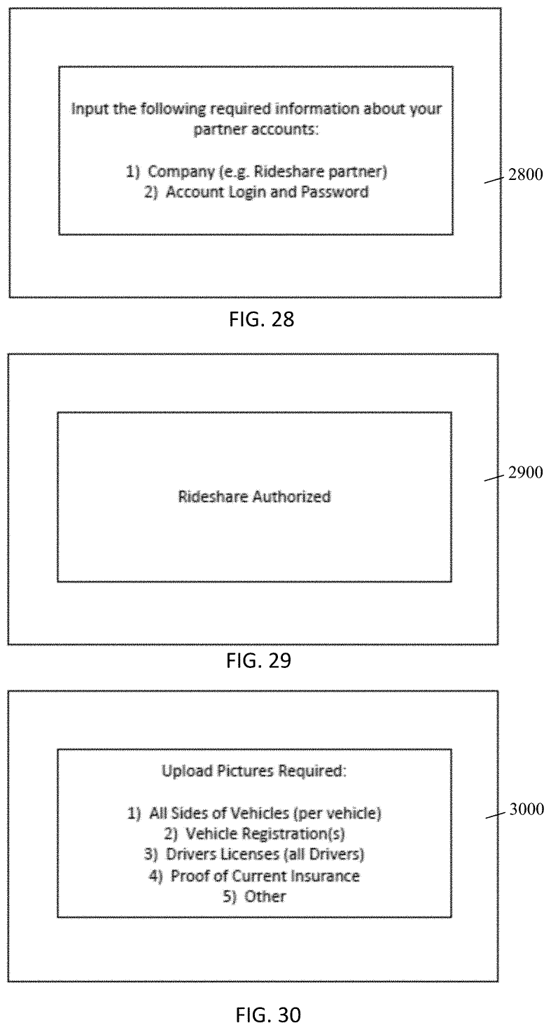

FIG. 28 is a schematic diagram showing a user interface screen 2800 in “wireframe” form for the applicant to provide information about the applicant's partner accounts (e.g., rideshare companies for which the applicant drives, social media partners or delivery companies), in accordance with one exemplary embodiment.

FIG. 29 is a schematic diagram showing a user interface screen 2900 in “wireframe” form for providing confirmation to the applicant after partner authentication, in accordance with one exemplary embodiment.

FIG. 30 is a schematic diagram showing a user interface screen 3000 in “wireframe” form for the applicant to upload various types of pictures used in the application process, in accordance with one exemplary embodiment.

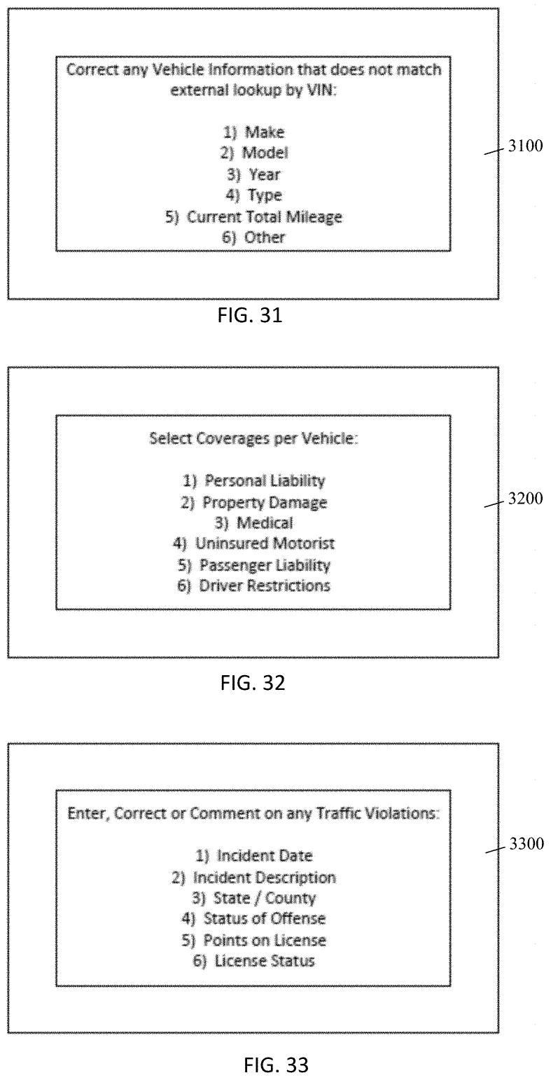

FIG. 31 is a schematic diagram showing a user interface screen 3100 in “wireframe” form for the applicant to enter and/or correct vehicle information, in accordance with one exemplary embodiment.

FIG. 32 is a schematic diagram showing a user interface screen 3200 in “wireframe” form for the applicant to select coverages for the vehicle, in accordance with one exemplary embodiment.

FIG. 33 is a schematic diagram showing a user interface screen 3300 in “wireframe” form for the applicant to enter, correct, and comment on any traffic violations of the applicant, in accordance with one exemplary embodiment.

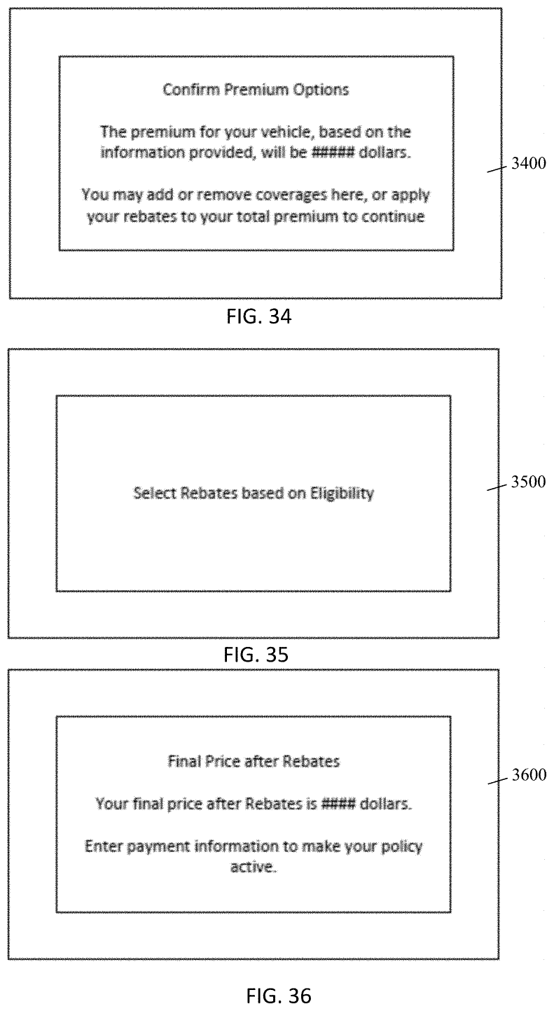

FIG. 34 is a schematic diagram showing a user interface screen 3400 in “wireframe” form for providing insurance premium information to the applicant, in accordance with one exemplary embodiment.

FIG. 35 is a schematic diagram showing a user interface screen 3500 in “wireframe” form for the applicant to select rebate programs for which the applicant is eligible, in accordance with one exemplary embodiment. For example, the Server System 102 may present rebate programs for which the applicant is eligible, and the applicant may select some or all rebates programs.

FIG. 36 is a schematic diagram showing a user interface screen 3600 in “wireframe” form for providing updated insurance premium information to the applicant after eligible rebates (e.g., initial sign-up rebate), in accordance with one exemplary embodiment.

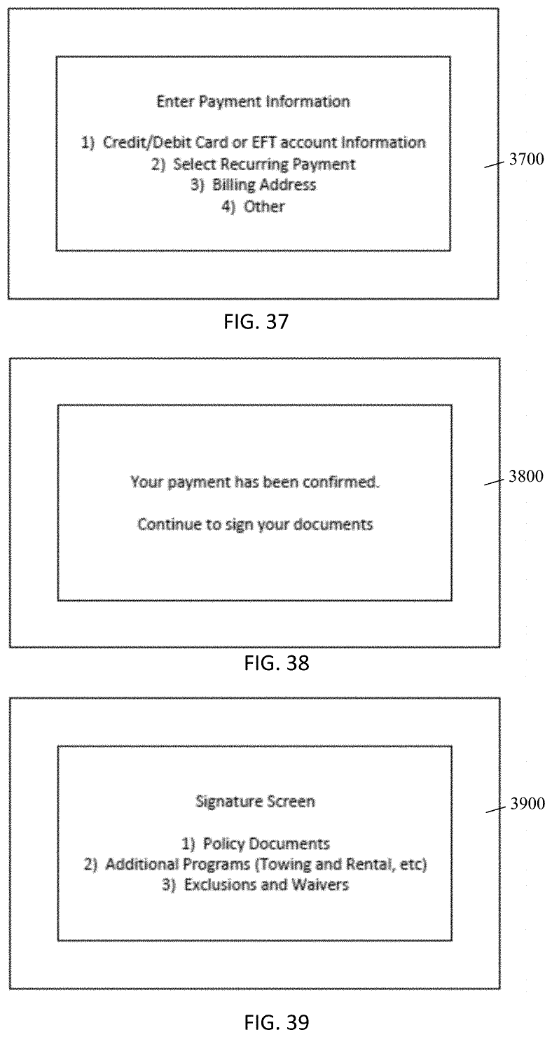

FIG. 37 is a schematic diagram showing a user interface screen 3700 in “wireframe” form for the applicant to enter payment information to pay the updated insurance premium, in accordance with one exemplary embodiment.

FIG. 38 is a schematic diagram showing a user interface screen 3800 in “wireframe” form for confirming receipt of payment, in accordance with one exemplary embodiment.

FIG. 39 is a schematic diagram showing a user interface screen 3900 in “wireframe” form for the applicant to sign various documents involved with the application process, in accordance with one exemplary embodiment.

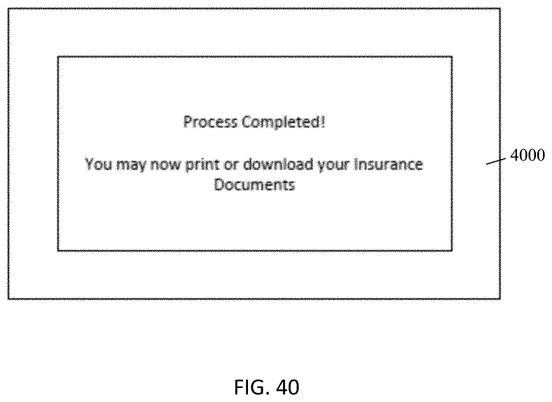

FIG. 40 is a schematic diagram showing a user interface screen 4000 in “wireframe” form for confirming completion of the application process, in accordance with one exemplary embodiment.

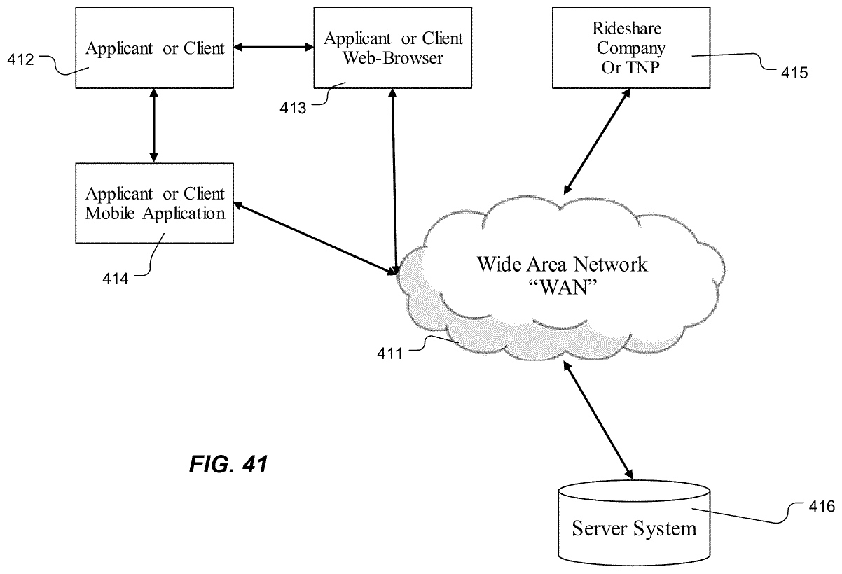

FIG. 41 is a schematic diagram showing a configuration, in accordance with an embodiment of the present invention, by which a driver applicant or client 412 becomes a “monitored driver” when the driver operates independently as an individual transportation network provider (TNP). In this example, a single TNP driver 412 enrolls himself and vehicle directly through their TNP application, mobile application 414 or web-browser 413. The Server System 416 interfaces over Wide Area Network 411 directly to the Rideshare or TNP Company's application, mobile application or web-browser 415.

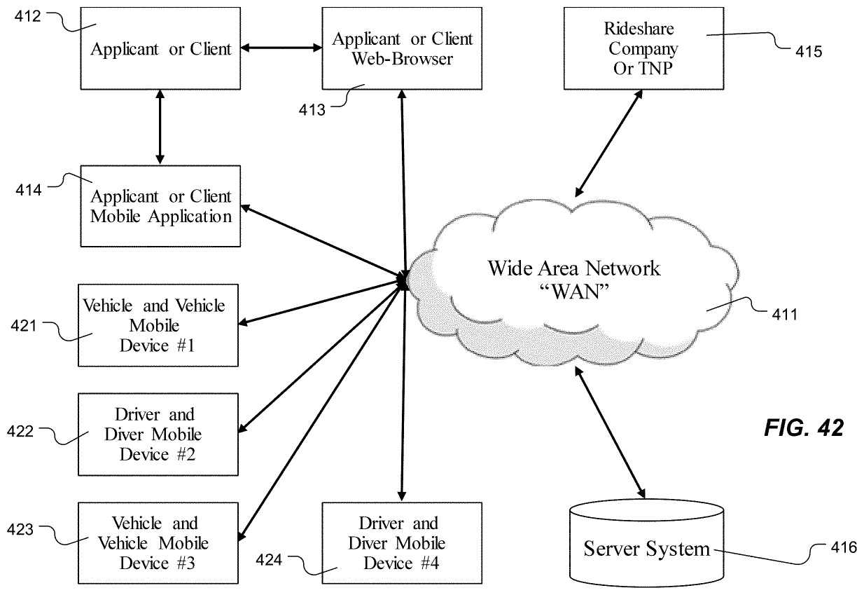

FIG. 42 is a schematic diagram showing a configuration, in accordance with an embodiment of the present invention, by which a driver applicant 412 becomes a “monitored driver” when the driver operates as one of a team of drivers of a fleet of vehicles managed by a fleet operator that serves as a transportation network provider. In this example, a single TNP Fleet Operator 415 enrolls his drivers and vehicles directly through their TNP application, mobile application 414 or web-browser 413. The Server System 416 interfaces directly over Wide Area Network 411 to the Rideshare or TNP Company's application 415, mobile application 414 or web-browser 413 as well as the mobile devices deployed with each fleet driver and vehicle directly or indirectly. Drivers and vehicles may have their own devices 421, 422, 423, and 424 or a single shared device logging activity.

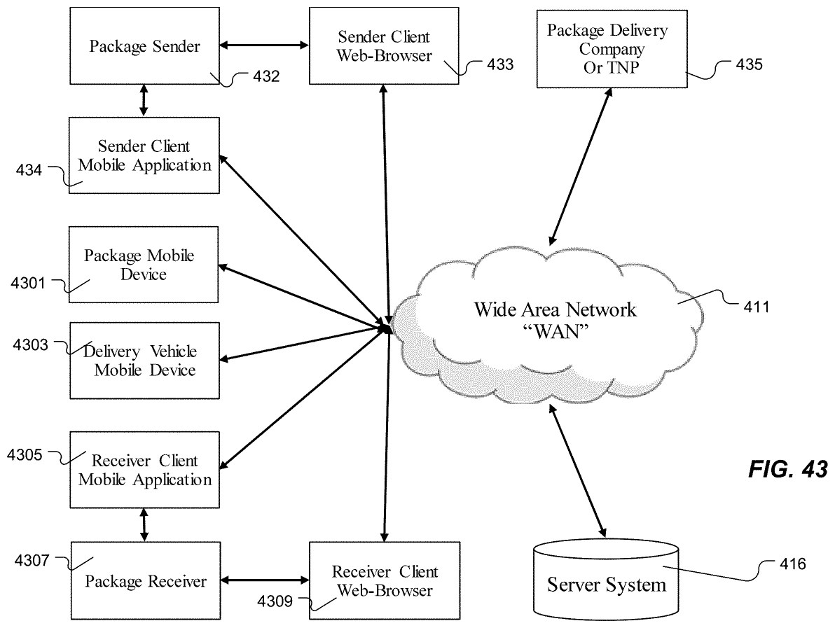

FIG. 43 is a schematic diagram showing a configuration, in accordance with an embodiment of the present invention, by which a driver becomes a “monitored driver” when the driver operates a motor vehicle for the purpose of providing a package delivery service either individually or as one of a team of drivers of a fleet of vehicles of a transportation network provider. In this example, a single TNP Fleet Operator 435 enrolls his drivers and vehicles directly through their TNP application, mobile application or web-browser. The Server System 416 interfaces directly over Wide Area Network 411 with the Rideshare or TNP Company's application 434, mobile application or web-browser as well as the mobile devices 4303 deployed with each fleet driver and vehicle directly or indirectly. Drivers and vehicles may have their own devices or a single shared device logging activity. In this system, there is also interaction with the web browser of the sender 433, of the receiver 4309, and the package receiver 4307. Optionally, there may be associated with the package a mobile device 4301.

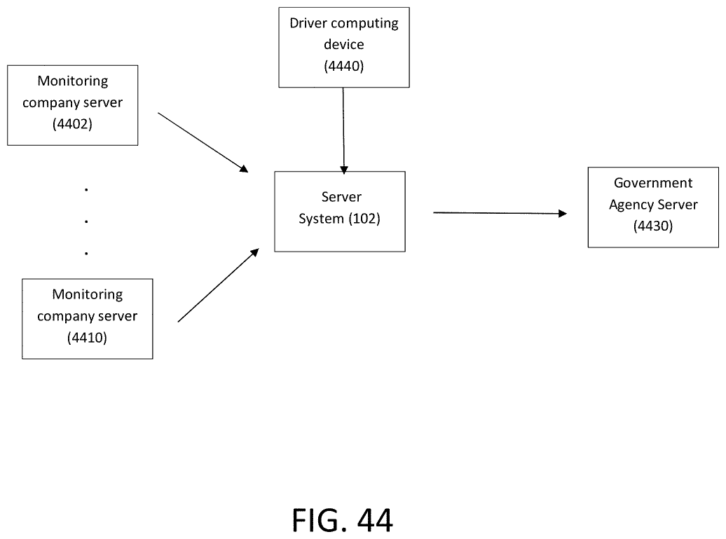

FIG. 44 is a block diagram showing architecture of a system, in accordance with an embodiment of the present invention, by which the Server System 102 of FIG. 2 facilitates applying on behalf of a driver to a government agency for monetary relief, using, in part, the driver's data received from monitoring companies. As in the embodiments of FIG. 1, the government agency may act as a bank 108 (e.g., through the Department of the Treasury or Federal Reserve), a rebate partner 106 (e.g., through the IRS) and as a financing partner 104 (e.g., through the SBA).

For monitored drivers enrolled in the Server System 102 of FIG. 2, the Server System 102 receives, correlates, and stores data, from the contemporaneous data feeds of monitoring company (TNC) servers 4402, . . . , 4410, as described in connection with FIG. 2. The Server System 102 further prepares an electronic application, for applying on behalf of one of the enrolled driver, to the government agency 4430 for monetary relief. The Server System 102 prepares the application using stored data received for the enrolled driver from the contemporaneous data feeds of the monitoring company (TNC) servers 4402, . . . , 4410, and from the enrolled driver's system profile. The Server System 102 prompts the enrolled driver, via an application running in the driver's computing device 4440, for any further information needed for the application. The Server System 102 communicates the completed application, on behalf of the driver, to the government agency server 4430.

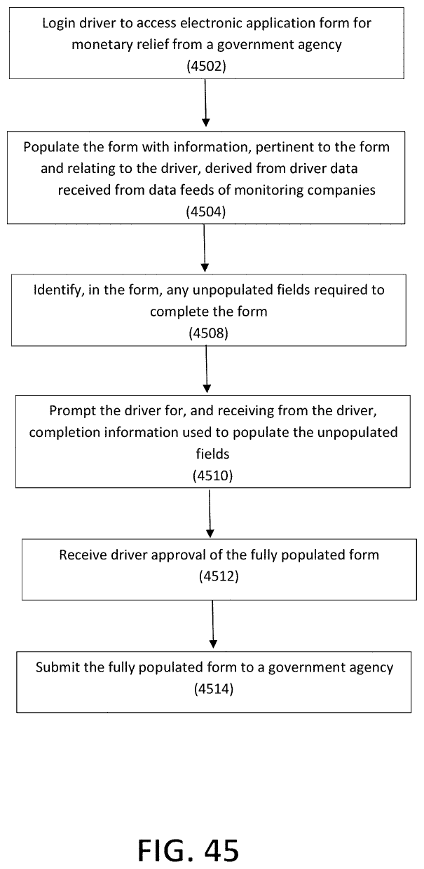

FIG. 45 is a block diagram of logical flow associated with a submission process, executed by the Server System of FIG. 2 in the configuration of FIG. 44, using an electronic application form populated, in part, with the driver's data received from the monitoring companies, in accordance with an exemplary embodiment of the present invention. The submission process is performed by computer processes executing on the Server System 102. A first computer process 4502, logs an enrolled driver into the Server System 102 and presents to the driver, via an application executing in the driver's computing device 4440, an electronic application form for applying for monetary relief from a government agency. The electronic application form is in a format approved by the agency and includes fields pertinent to the monetary relief. In some embodiments, the government agency is the Small Business Administration (SBA).

A second computer process 4504, populates automatically the form with information, pertinent to the form and relating to the driver, derived from the stored driver data received from the contemporaneous data feeds of the monitoring companies 4402, . . . , 4410. For example, stored driver data, for the enrolled driver, received from the data feeds of multiple monitoring companies may be used, by the Server System 102, for calculating a value to populate a field of the form. In some embodiments, the information derived from this stored driver data includes combined gross revenue of the enrolled driver from the set of monitoring companies. In some embodiments, the information derived from this stored driver data includes combined cost of goods sold by such driver from the set of monitoring companies. The second computer process 4504 also populates automatically the form with other information, pertinent to the form, maintained for the enrolled driver, such as an address and telephone number.

A third computer process 4508, identifies, in the form, any unpopulated fields required to complete the form. A fourth computer process 4510, via the application executing in the driver's computing device 4440, prompts the driver for, and receives from the driver, completion information used to populate the unpopulated fields of the form. The fourth computer process 4510 uses the completion information to populate the unpopulated fields of the form. In some embodiments, the completion information includes a data item selected from the group consisting of personal information of the driver, business information of the driver, financial information of the driver, and combinations thereof.

A fifth computer process 4512, receives approval, from the driver via the application executing in the driver's computing device 4440, to submit the fully populated form. In some embodiments, the fifth computer process 4512 receives the approval by prompting the enrolled driver for, and receiving from the enrolled driver, an electronic signature. A sixth computer process 4514, submits the fully populated form to the government agency server 4430.

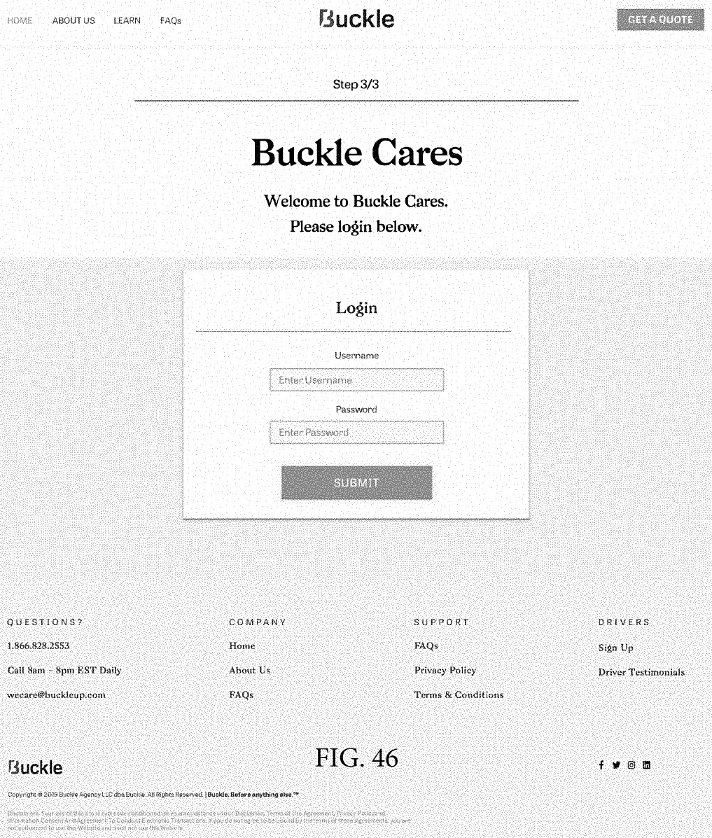

FIG. 46 is a representation of a display coupled to the Server System 102 and presenting a user interface for entry of login information, by an enrolled driver, to access an electronic application form for applying to a government agency for monetary relief, in accordance with one exemplary embodiment of the present invention.

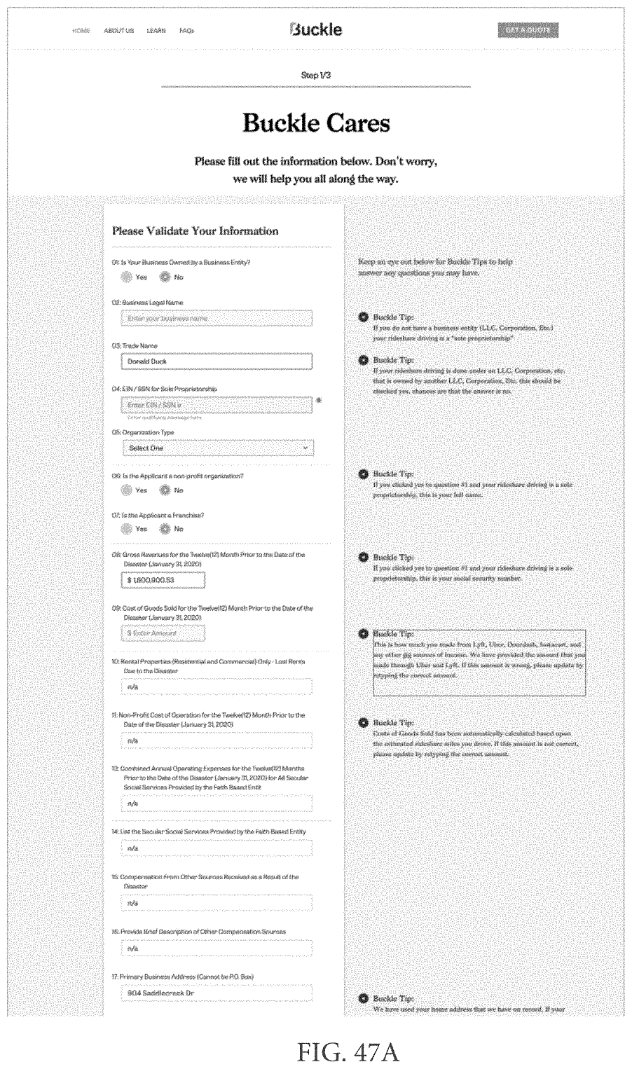

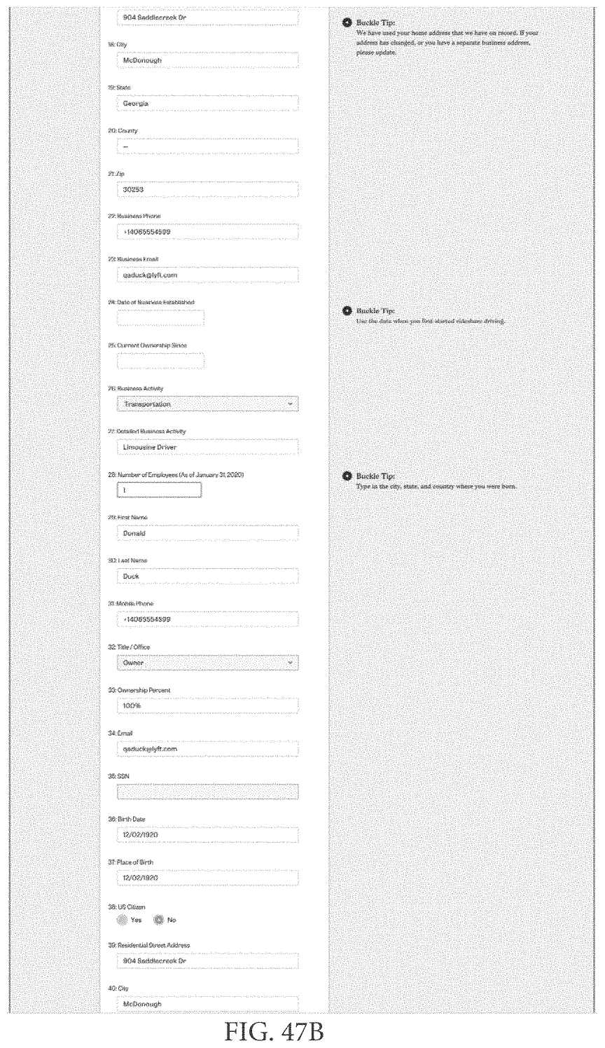

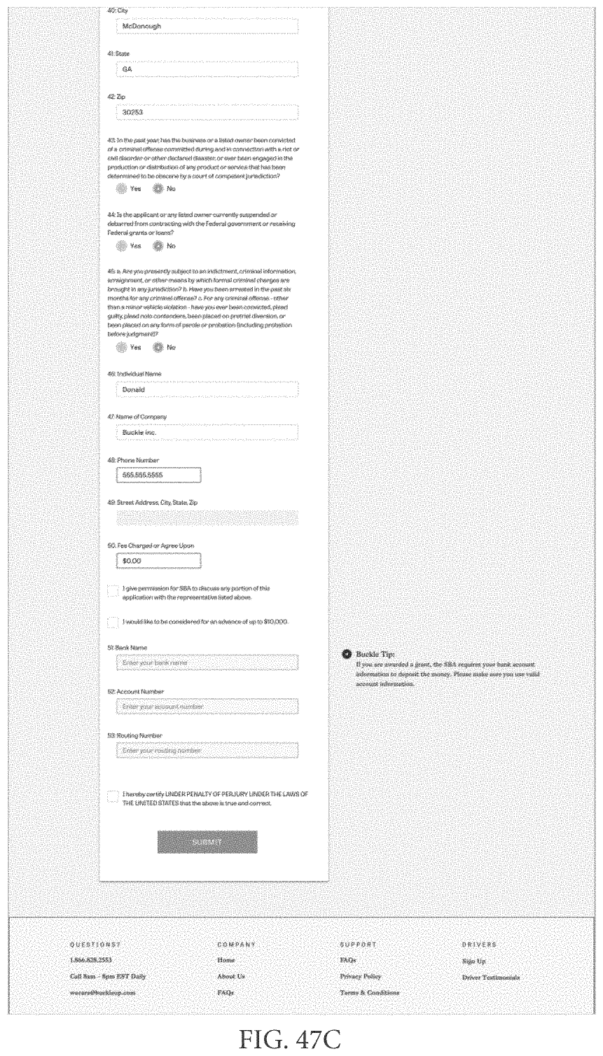

FIGS. 47A-47C are representations of a user interface screen presenting the electronic application form accessible via the login screen of FIG. 46, in accordance with one exemplary embodiment of the present invention. The electronic application form of FIGS. 47A-47C includes fields populated automatically for the enrolled driver from the data received from the contemporaneous data feeds of the monitoring companies, such as 08: gross revenue for the twelve (12) months prior to the date of the disaster and :09: cost of goods sold for the twelve (12) months prior to the date of the disaster. The electronic application form also includes fields populated automatically from enrollment information maintained for the enrolled driver by the Server System 102 (e.g., enrolled driver's system profile), such as 029: First name, 030: Last name, 031: Mobile phone number, etc. The electronic application form further includes unpopulated fields that the enrolled driver is prompted to populate, such as 04: EIN/SSN for sole proprietorship.

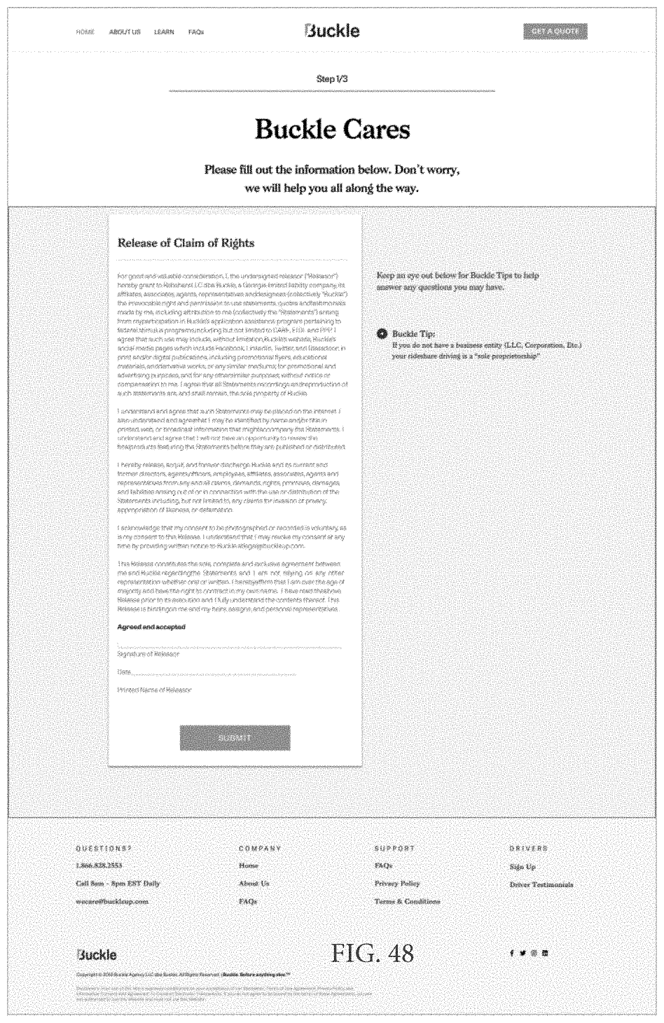

FIG. 48 is a representation of a user interface screen which a driver can enter an electronic signature to indicate approval of the completed electronic application form of FIGS. 47A-47C, in accordance with one exemplary embodiment of the present invention.

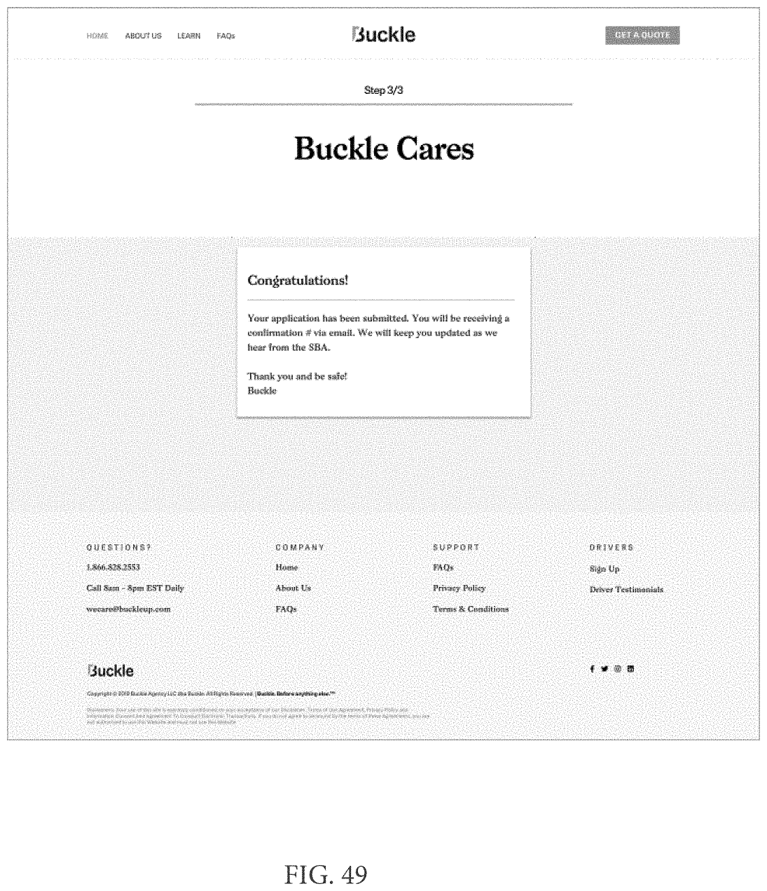

FIG. 49 is a representation of a screen providing to the user a confirmation of submission of the completed and approved electronic application form of FIGS. 47A-47C to the government agency, in accordance with one exemplary embodiment of the present invention.

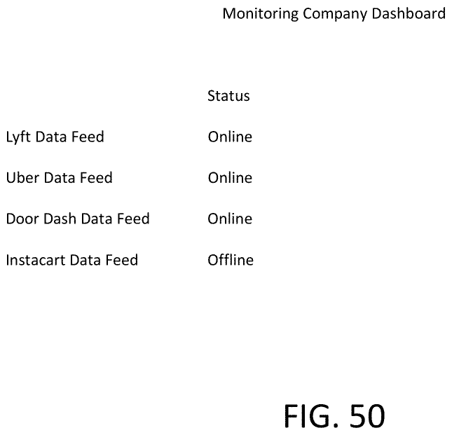

FIG. 50 is a representation of a dashboard screen providing status information as to which monitoring companies are online and thus active in providing, to the Server System of FIG. 2, driver data that is included in calculations used to populate the electronic application form of FIGS. 47A-47C, in accordance with one exemplary embodiment of the present invention. In the dashboard screen of FIG. 50, the status of “online” indicates that the corresponding monitoring company is in communication with the Server System 102 and providing driving data that is included in such calculations. The status of “offline” indicates that the corresponding monitoring company is not currently in communication with the Server System 102, and, therefore, not providing driving data for such calculations.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions. Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

It should be noted that terms such as “client,” “server,” “processor,” etc. (e.g., in the context of the Server System 102 or various types of user devices such as mobile communication devices) may be used herein to describe devices that may be used in certain embodiments of the present invention and should not be construed to limit the present invention to any particular device type unless the context otherwise requires. Such devices typically include one or more network interfaces for communicating over a communication network and a processor (e.g., a microprocessor with memory and other peripherals and/or application-specific hardware) configured accordingly to perform device functions. Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium. Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message. Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

Computer program logic implementing all or part of the functionality previously described herein may be executed at different times on a single processor (e.g., concurrently) or may be executed at the same or different times on multiple processors and may run under a single operating system process/thread or under different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., the Server System 102, mobile applications, and web pages described herein) are necessarily non-conventional because, absent special programming or configuration, the conventional components do not inherently perform the described non-conventional methods.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method, using computer processes executing on an administrator server system, that administers a program having a targeted set of terms, based on a set of contracts involving a set of services, pertaining to monitored drivers, wherein the computer processes additionally facilitate applying on behalf of an applicant set of the monitored drivers to a government agency for monetary relief, and wherein the computer processes comprise:
receiving, by the administrator server system, a set of first data feeds from a set of servers of a set of monitoring companies that (i) compensate the monitored drivers for driving services or (ii) provide non-driving contractual services to the drivers or (iii) both compensate the monitored drivers for the driving services and provide the non-driving contractual services to the monitored drivers, wherein each one of the monitored drivers performs services as a driver of a motor vehicle of which the use is monitored in real time by means of at least one application executing on a mobile computing device in communication with a server operated by one of the monitoring companies, wherein such first data feeds provide contemporaneous information concerning performance of the monitored drivers;
maintaining a driver database containing data, as to a set of the monitored drivers, wherein the driver database includes the targeted set of terms of the contractual service;
parsing, by the administrator server system, the first data feeds in relation to the set of monitored drivers, to derive updated data pertinent to one or more affected drivers in the set, and, processing the updated data by:
storing, by the administrator server system, the updated data in relation to the affected drivers in the driver database;
in a performance review process, evaluating the updated data in relation to other data in the driver database with respect to each affected driver to determine an adjustment with respect to the targeted set of terms for each affected driver; and
in a result communication process, communicating by the administrative server system an adjustment to each affected driver;
wherein the targeted terms are dynamically adjusted based at least on contemporaneous driver performance determined at least in part by the set of data feeds from the set of servers of the set of monitoring companies; and
in a submission process, for each driver in the application set of drivers,
populating, by the administrator server system, an electronic application form, in a format approved by the agency and pertinent to the monetary relief, with information, pertinent to the form and relating to such driver, the information derived from the driver database;
identifying, by the administrator server system, in the application form, any unpopulated fields required to be completed;
prompting, by the administrator server system, such driver for, and receiving from such driver, completion information needed to populate the unpopulated fields;
using, by the administrator server system, the completion information to populate the unpopulated fields; and
thereafter submitting, by the administrator server system and on behalf of such driver, the form, as fully populated, to the agency.

2. A computer-implemented method according to claim 1, wherein the information derived from the driver database includes combined gross revenue of such driver from the set of monitoring companies.

3. A computer-implemented method according to claim 1, wherein the information derived from the driver database includes combined cost of goods sold by such driver from the set of monitoring companies.

4. A computer-implemented method according to claim 1, wherein submitting the form includes causing, by the administrator server system, prompting of such driver for, and receiving from such driver, an electronic signature.

5. A computer-implemented method according to claim 1, wherein the completion information includes a data item selected from the group consisting of personal information of such driver, business information of such driver, financial information of such driver, and combinations thereof.

6. A computer-implemented method according to claim 1, wherein the government agency is the Small Business Administration (SBA).

7. A computer-implemented method according to claim 1, wherein the monetary relief is disaster relief.

8. A computer-implemented method according to claim 1, wherein the computer processes further comprise causing, by the administrator server system, presentation of the form to such driver, and prompting of such driver for the completion information, via an application executing on a computing device, operated by such driver, in communication with the administrator server system.

9. A computer-implemented method according to claim 1, wherein the contractual service is selected from the group consisting of life insurance, health insurance, motor vehicle insurance, disability insurance, workman's compensation insurance, home or renter's insurance, commercial liability insurance, umbrella insurance, a loan, a provision on a consumable, a car buying service, a referral service, and the result, determined by the performance review process, is a rebate on the contractual service.

10. A computer-implemented method according to claim 1, wherein the mobile computing device monitoring use of the motor vehicle is carried in a manner selected from the group consisting of (i) carried by the driver, (ii) installed in the vehicle, (iii) carried by a passenger when the vehicle is used for providing a ride service, (iv) affixed to or contained in a package when the vehicle is used for providing a package delivery service, and (v) combinations of the foregoing.
